(19) United States
(12) Patent Application Publication
(10) Pub. No.: US 2025/0242265 A1
(43) Pub. Date: Jul. 31, 2025

(54) STORAGE MEDIUM, INFORMATION PROCESSING SYSTEM, AND INFORMATION PROCESSING METHOD

(71) Applicant: NINTENDO CO., LTD., Kyoto (JP)

(72) Inventors: Hiroyuki SASAKI, Kyoto (JP); Tatsuya KURIHARA, Kyoto (JP); Yusaku YAMANAKA, Kyoto (JP)

(21) Appl. No.: 19/036,877

(22) Filed: Jan. 24, 2025

(30) Foreign Application Priority Data
Jan. 30, 2024 (JP) 2024-011599

(51) Int. Cl. A63F 13/69; A63F 13/577; G06T 17/20

(52) U.S. Cl. CPC A63F 13/69; A63F 13/577; G06T 17/205

(57) ABSTRACT

At least a portion of a stage object included in a game stage in a virtual space is removed, based on a user's operation input. A cumulative value of reduced amounts of the stage object caused by the removal in the virtual space is calculated. A placed object different from the stage object is placed in the vicinity of a location where the stage object has been removed, depending on the cumulative value.

### CROSS REFERENCE TO RELATED APPLICATION

This application claims priority to Japanese Patent Application No. 2024-011599, filed on Jan. 30, 2024, the entire contents of which are incorporated herein by reference.

### FIELD

The technology disclosed herein relates to a storage medium, information processing system, information processing apparatus, and information processing method that execute a process using a game stage in a virtual space.

### BACKGROUND AND SUMMARY

There is a conventional game program that executes a game in which when a player character breaks a block in a virtual space according to a user's operation input, an item appears from the block.

However, in the game executed by the above game program, the user is not very strongly motivated to break and remove a game stage. Therefore, there is room for improvement in the motivation.

With the above in mind, the present example discloses a storage medium, information processing system, information processing apparatus, and information processing method that are capable of improving the user's motivation for removing a game stage.

The present example may have the following features, for example.

An example configuration of a non-transitory computer-readable storage medium having stored therein an information processing program according to the present example is executed by one or more processors of an information processing apparatus. The information processing program causes the one or more processors to execute information processing comprising: removing at least a portion of a stage object included in a game stage in a virtual space, based on a user's operation input; calculating a cumulative value of reduced amounts of the stage object caused by the removal in the virtual space; and placing a placed object different from the stage object in the vicinity of a location where the stage object has been removed, depending on the cumulative value.

Thus, a placed object newly appears according to an operation input to remove a stage object, resulting in an improvement in the user's motivation for removing a stage object.

The placing the placed object may include placing the placed object with the placed object buried in a surface of the stage object in the vicinity of the location of the removal.

Thus, the user can be guided to a location of a placed object buried in a stage object, and therefore, can be prompted to further break the stage object from that location.

The removing the stage object may include releasing the placed object from a state of being buried in the stage object or causing the user to obtain the placed object, by further removing a portion of the stage object in which the placed object is buried, based on the operation input.

Thus, as it is necessary to further remove a stage object in order to obtain a placed object, the user can be further prompted to remove a stage object.

The placing the placed object may include placing the placed object when the cumulative value exceeds a reference value.

Thus, a placed object can be caused to appear at an intended frequency.

The calculating the cumulative value may include reducing the cumulative value when the placed object is placed as the cumulative value exceeds a reference value.

Thus, a placed object can be repeatedly caused to appear at an intended frequency.

The calculating the cumulative value may include calculating the cumulative value for each type of a placed object that is to be placed, wherein when any of the placed objects is placed as the cumulative value exceeds the reference value, the cumulative value for the placed object may be reduced.

Thus, various placed objects can be caused to appear.

The calculating the cumulative value may include setting different reference values for different types of placed objects that are to be placed.

Thus, a placed object can be caused to appear at a frequency corresponding to the type thereof.

The placing the placed object may include further forming a cavity in the stage object in the vicinity of the removed portion of the stage object, and placing the placed object in the cavity, depending on the cumulative value.

Thus, an open space is further formed in a stage object, and a placed object is placed in the space. Therefore, the user's attention can be attracted, and thereby, can be further promoted to remove a stage object.

The placing the placed object may include not forming the cavity and not placing the placed object to be placed in the cavity, when there is not enough space in the stage object to form the cavity, depending on the cumulative value.

Thus, a cavity that penetrates through a stage object can be prevented from being formed.

The calculating the cumulative value may include decreasing the cumulative value when the cavity is formed and the placed object is placed in the cavity, and maintaining the cumulative value unchanged when there is not enough space in the stage object to form the cavity.

Thus, a cumulative value is not reset, even in a situation in which a placed object cannot be placed in a cavity. Therefore, an attempt to place a placed object can be immediately made again.

The calculating the cumulative value may include decreasing the cumulative value to a first value when the cavity is formed and the placed object is placed in the cavity, and decreasing the cumulative value to the first value or a value greater than the first value when there is not enough space in the stage object to form the cavity.

Thus, a situation in which a placed object cannot be placed in a cavity can be prevented from continuously occurring. Therefore, the load of a process for placing the placed object can be reduced.

The placing the placed object may include determining whether to further form the cavity and place the placed object in the cavity or place the placed object without further forming the cavity, depending on a direction in which the stage object has been removed.

Thus, a placed object that is suitable for a direction in which a stage object has been removed can be caused to appear.

The stage object may have attribute information. The calculating the cumulative value may include varying an incremental amount of the cumulative value according to the attribute information even when the reduced amount is the same.

Thus, a placed object can be caused to appear according to attribute information of a removed stage object.

The removing the stage object may include varying a required amount of the operation input required for removing at least a portion of the stage object according to the attribute information. The calculating the cumulative value may include increasing an incremental amount of the cumulative value with an increase in the required amount even when the reduced amount is the same.

Thus, even when a required amount of an operation input is large, the frequency of appearance of a placed object does not decrease significantly. Therefore, the user is further prompted to remove a stage object.

The stage object may ha attribute information. The placing the placed object may include determining whether or not to place the placed object, depending on the attribute information of the stage object in the vicinity of the location where the stage object has been removed.

Thus, whether or not to place a placed object can be determined, depending on whether or not an attribute of a stage object indicates that the stage object is suitable to place the placed object.

The placing the placed object may include placing the placed object in a direction in which at least a portion of the stage object has been removed.

Thus, the user can be prompted to continuously remove a stage object in the same direction.

The placing the placed object may include placing, when the stage object is absent on an opposite side from a direction of gravity in the virtual space of a location where at least a portion of the stage object has been removed, the placed object at a location closer to the direction of gravity than the direction in which at least a portion of the stage object has been removed.

Thus, a situation in which as a stage object is removed on the earth, a stage object for causing a placed object to appear is absent in a direction in which a placed object is to be placed, can be prevented.

The stage object may include a mesh generated from voxel data including at least density data. The removing the stage object may include removing at least a portion of the stage object by changing the density data.

Thus, a placed object appears based on density data included in voxel data. Therefore, the user can be more surprised than when the appearance is based on a discrete value such as the number of broken blocks.

A reduced amount of the stage object formed of the mesh may be allowed to take a value smaller than the amount of a voxel with which each of the voxel data is associated.

Thus, a placed object appears based on density data included in voxel data. Therefore, the user can be more surprised than when the appearance is based on a discrete value such as the number of broken blocks.

The removing the stage object may include placing, when at least a portion of the stage object is removed, an amount of voxel objects corresponding to the reduced amount on the stage object with the voxel objects separated from the stage object. The calculating the cumulative value may include calculating the reduced amount of the stage object, including the amount of voxel objects placed separately from the stage object.

Thus, even when a portion of a stage object is separated, the separated portion of the stage object is assumed to be removed. Therefore, even in that situation, a placed object can be caused to appear.

The information processing may further comprise: controlling the player character's action in the virtual space, based on the operation input. The removing the stage object may include removing at least a portion of the stage object according to the player character's action in the virtual space. The calculating the cumulative value may include calculating a cumulative value of reduced amounts of the stage object removed according to the player character's action.

Thus, a stage object can be removed, based on an operation input to cause a player character to perform an action.

The information processing may further comprise: controlling an action in the virtual space of an opponent character different from the player character. The removing the stage object may include removing at least a portion of the stage object according to the opponent character's action in the virtual space. In the calculating the cumulative value, a reduced amount of the stage object removed according to the opponent character's action may not be used in the calculation of the cumulative value.

Thus, removal of a stage object caused by other characters can be prevented from affecting the frequency of appearance of a placed object.

Another example configuration of a non-transitory computer-readable storage medium having stored therein an information processing program according to the present example is executed by one or more processors of an information processing apparatus. The information processing program causes the one or more processors to execute information processing comprising: removing at least a portion of a stage object included in a game stage in a virtual space, based on a user's operation input; and placing and burying a placed object different from the stage object in a surface of the stage object in the vicinity of a location where the stage object has been removed, depending on the removal. The removing the stage object includes releasing the placed object from a state of being buried in the stage object or causing the user to obtain the placed object, by further removing a portion of the stage object in which the placed object is buried, based on the operation input.

Thus, a placed object can be caused to appear based on an operation input to remove a stage object, and can be obtained by an additional operation input to remove the stage object, resulting in an improvement in the user's motivation for removing a stage object.

The present example may also be carried out in the form of an information processing apparatus, information processing system, and information processing method.

According to the present example, the user's motivation for removing a stage object can be improved.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a diagram showing a non-limiting example of a state where a left controller 3 and a right controller 4 are attached to a main body apparatus 2,

FIG. 2 is a diagram showing a non-limiting example of a state where a left controller 3 and a right controller 4 are detached from a main body apparatus 2, FIG. 3 shows six orthogonal views of a non-limiting example of a main body apparatus 2,

FIG. 4 shows six orthogonal views of a non-limiting example of a left controller 3,

FIG. 5 shows six orthogonal views of a non-limiting example of a right controller 4,

FIG. 6 is a block diagram showing a non-limiting example of an internal configuration of a main body apparatus 2,

FIG. 7 is a block diagram showing non-limiting examples of internal configurations of a main body apparatus 2, a left controller 3, and a right controller 4, FIG. 8 is a view showing a non-limiting example of a terrain object, which is a voxel object,

FIG. 9 is a view showing a non-limiting example before removal of a portion of the terrain object shown in FIG. 8,

FIG. 10 is a view showing a non-limiting example after removal of a portion of the terrain object shown in FIG. 8,

FIG. 11 is a diagram showing a non-limiting example of content of voxel data, FIG. 12 is a diagram showing a non-limiting example of property information representing properties of materials,

FIG. 13 is a diagram showing a non-limiting example of texture information representing textures of materials,

FIG. 14 is a diagram showing a non-limiting example of a method for generating a mesh,

FIG. 15 is a diagram showing a non-limiting example of a game image including a terrain object,

FIG. 16 is a diagram showing a non-limiting example of a game image that is of a game space in which a terrain object TO and a player character PC are set, and that is displayed on a display 12,

FIG. 17 is a diagram showing a non-limiting example of a game image in which a portion of a terrain object TO has been removed by a player character PC,

FIG. 18 is a diagram showing a non-limiting example of a destruction range of voxels to be broken in a terrain object TO,

FIG. 19 is a diagram showing a non-limiting example of a game image indicating a situation in which a placed object OBJ is newly placed,

FIG. 20 is a diagram showing a non-limiting example of a game image indicating a situation in which a placed object OBJ is newly placed when a space in which a terrain object TO is absent is formed on the opposite side from a direction of gravity in a game space,

FIG. 21 is a diagram showing a non-limiting example of a game image indicating a situation in which a cavity is further formed in a terrain object TO, and a placed object OBJ is newly placed in the cavity,

FIG. 22 is a diagram showing a non-limiting example of various types of data used in an information process that is executed in a game system 1,

FIG. 23 is a flowchart showing a non-limiting example of a flow of a game process that is executed in a game system 1, and

FIG. 24 is a subroutine showing a non-limiting example of a placed object setting process of step S8 in the flowchart of FIG. 23.

### DETAILED DESCRIPTION OF NON-LIMITING EXAMPLE EMBODIMENTS

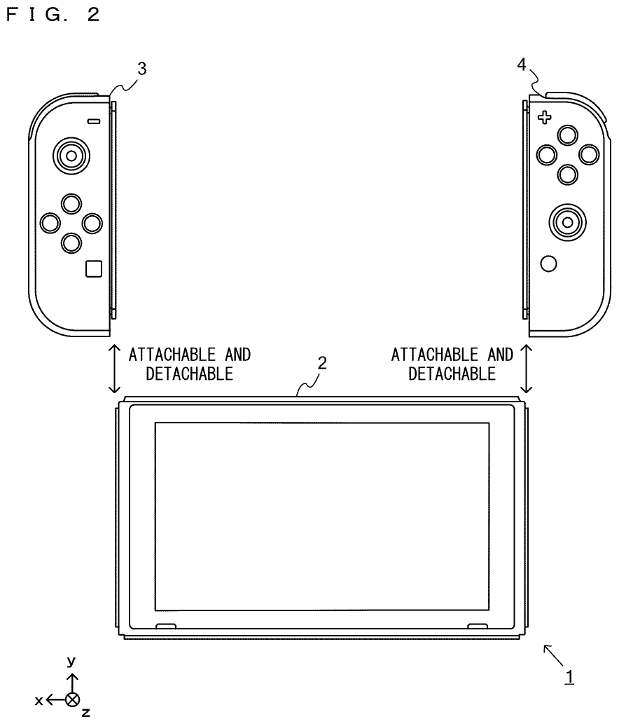

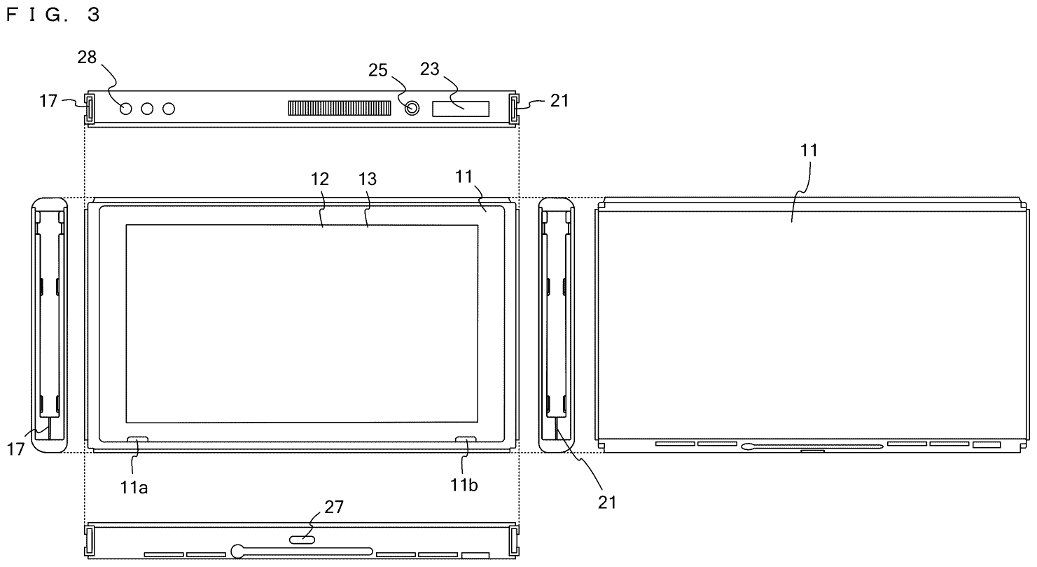

A game system according to the present embodiment will now be described. A non-limiting example of a game system 1 according to the present embodiment includes a main body apparatus (information processing apparatus serving as the main body of a game apparatus in the present embodiment) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the description that follows, a hardware configuration of the game system 1 of the present embodiment is described, and thereafter, the control of the game system 1 of the present embodiment is described.

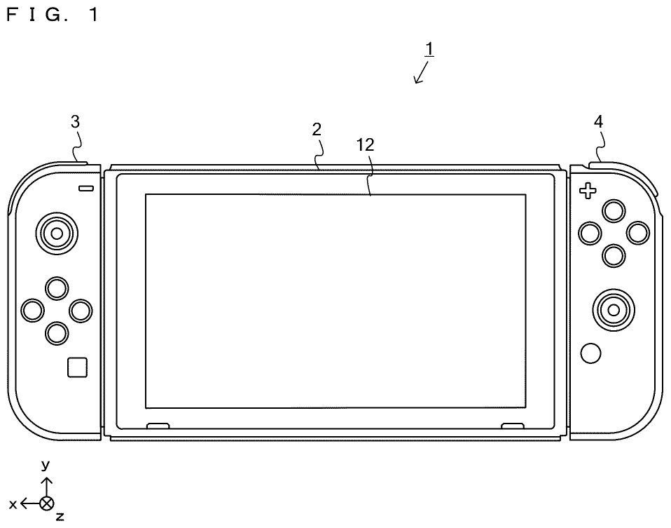

FIG. 1 is a diagram showing a non-limiting example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing a non-limiting example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

FIG. 3 shows six orthogonal views of a non-limiting example of the main body apparatus 2. As shown in FIG. 3, the main body apparatus 2 includes an approximately plate-shaped housing 11. In the present embodiment, a main surface (e.g., a surface on a front side, such as a surface on which the display 12 is provided) of the housing 11 has a generally rectangular shape.

It should be noted that the shape and the size of the housing 11 are optional. As a non-limiting example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the present embodiment, the display 12 is a liquid crystal display device (LCD). The display 12, however, may be a display device of any suitable type.

In addition, the main body apparatus 2 includes a touch panel 13 on the screen of the display 12. In the present embodiment, the touch panel 13 allows multi-touch input (e.g., a capacitive touch panel). It should be noted that the touch panel 13 may be of any suitable type, e.g., it allows single-touch input (e.g., a resistive touch panel).

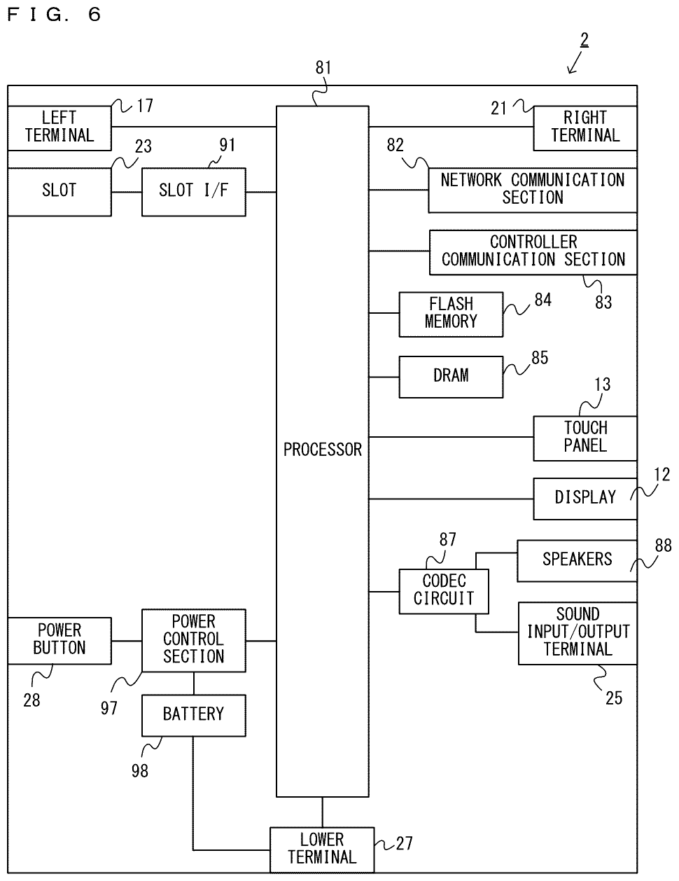

The main body apparatus 2 includes a speaker (e.g., a speaker 88 shown in FIG. 6) inside the housing 11. As shown in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present embodiment, the lower-side terminal 27 is a USB connector (more specifically, a female connector). When the unified apparatus or the main body apparatus 2 alone is placed on the cradle, the game system 1 can display, on a monitor, an image that is generated and output by the main body apparatus 2. The monitor may be stationary or may be movable. Also, in the present embodiment, the cradle has the function of charging the unified apparatus or the main body apparatus 2 alone, being placed thereon. The cradle also functions as a hub device (specifically, a USB hub).

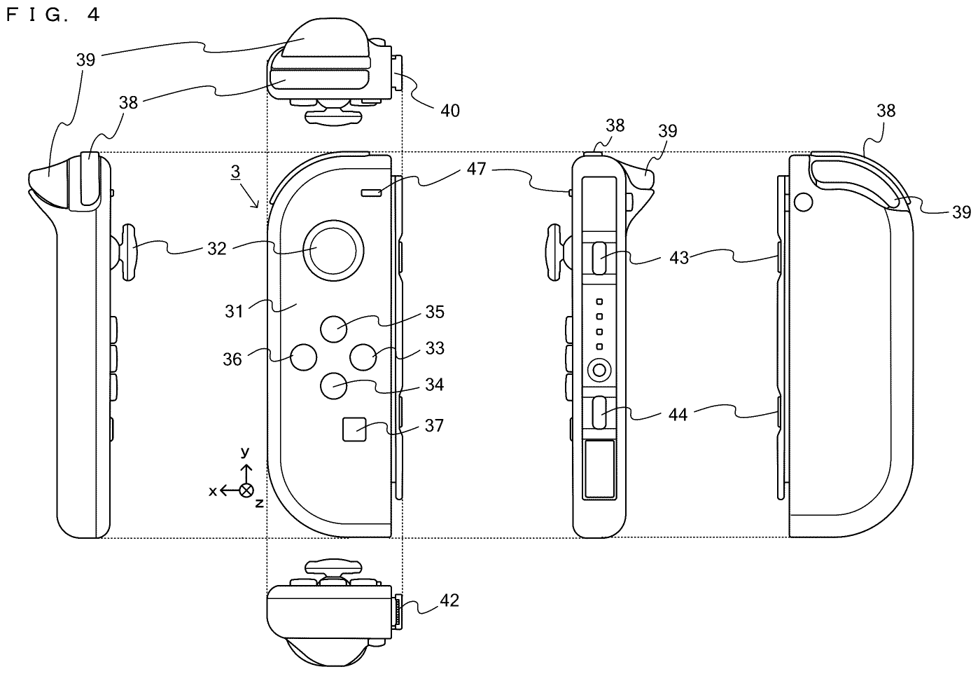

FIG. 4 shows six orthogonal views of a non-limiting example of the left controller 3. As shown in FIG. 4, the left controller 3 includes a housing 31. In the present embodiment, the housing 31 has a vertically long shape. The housing 31 may be shaped to be long in an up-down direction, e.g., along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

The left controller 3 also includes a terminal 42 that enables wired communication between the left controller 3 and the main body apparatus 2.

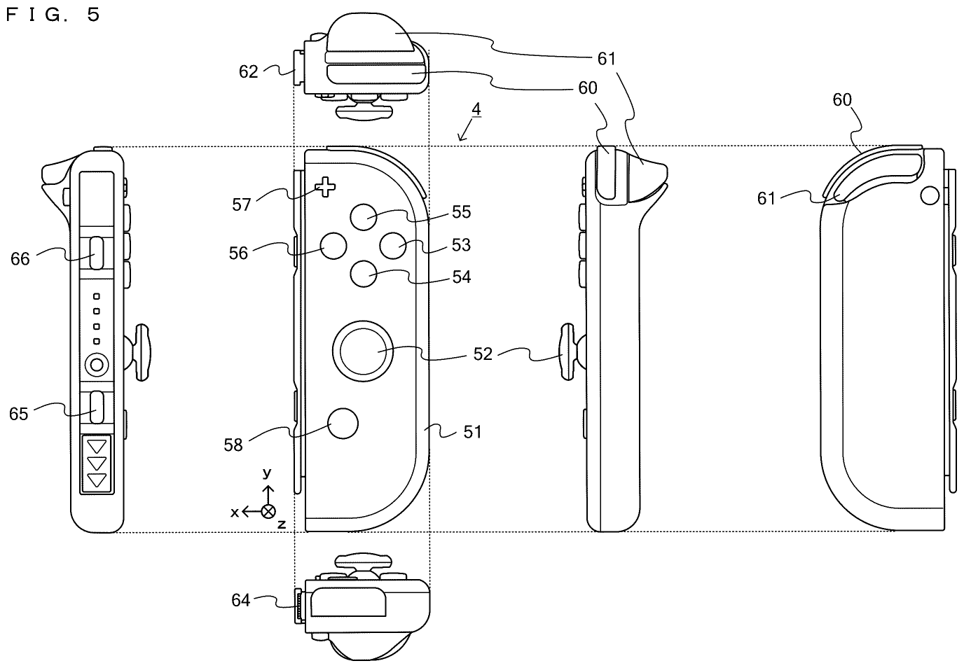

FIG. 5 shows six orthogonal views of a non-limiting example of the right controller 4. As shown in FIG. 5, the right controller 4 includes a housing 51. In the present embodiment, the housing 51 has a vertically long shape. For example, the housing 51 may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

FIG. 6 is a block diagram showing a non-limiting example of an internal configuration of the main body apparatus 2. The main body apparatus 2 includes components 81 to 91, 97, and 98 shown in FIG. 6 in addition to the components shown in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the CPU 81 may include only a central processing unit (CPU), or may be a system-on-a-chip (SoC) having a plurality of functions such as a CPU function and a graphics processing unit (GPU) function. The processor 81 executes an information processing program (e.g., a game program) or other instructions that are stored in a storage (e.g., an internal non-transitory storage medium such as a flash memory 84, an external non-transitory storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to temporarily store various data used in information processing. The DRAM 85 and the flash memory 84 are illustrative non-limiting examples of non-transitory computer-readable media.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to exchange data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present embodiment, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present embodiment, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As a non-limiting example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and an audio input/output terminal 25 and also connected to the processor 81. The codec circuit 87 is for controlling the input and output of audio data to and from the speakers 88 and the sound input/output terminal 25.

The main body apparatus 2 includes a power control section 97 and a battery 98. The power control section 97 is connected to the battery 98 and the processor 81. Further, although not shown, the power control section 97 is connected to components of the main body apparatus 2 (specifically, components that receive power supplied from the battery 98, the left-side terminal 17, and the right-side terminal 21). Based on a command from the processor 81, the power control section 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

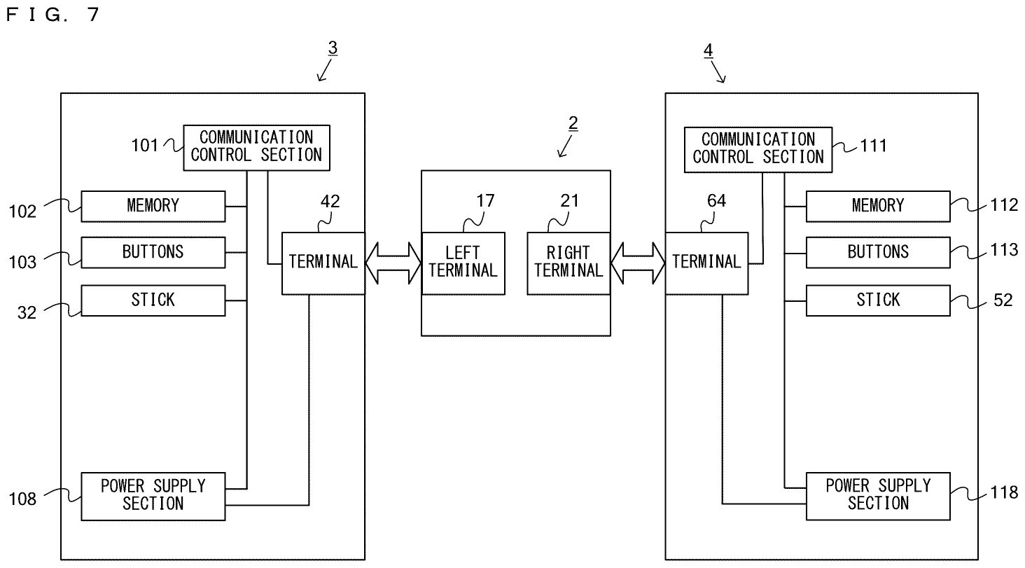

FIG. 7 is a block diagram showing non-limiting examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the present embodiment, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

Next, referring to FIG. 8 to FIG. 15, an outline of the process performed on the game system 1 will be described. In the present embodiment, the game system 1 generates a game image in which terrain objects and characters (e.g., a player character that is controlled by the player) are arranged in a game space, which is a three-dimensional virtual space, and displays the game image on a display device. Note that in the present embodiment, the display device on which the game image is displayed may be the display 12 described above, or may be a stationary monitor.

In the present embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the present embodiment, the game system 1 stores voxel data for each of a plurality of voxels that are set in the game space as data for generating voxel objects in the game space.

FIG. 8 is a view showing an example of a terrain object, which is a voxel object. As shown in FIG. 8, in the present embodiment, a terrain object representing a terrain such as a ground surface has its shape defined by voxel data. The cubes shown in FIG. 8 represent a terrain object. Note that in FIG. 8, edges of the terrain object are indicated by thick lines. However, the thick lines are added for the purpose of making the drawings easier to understand, and there is actually no need for edges of the terrain object to be drawn thick.

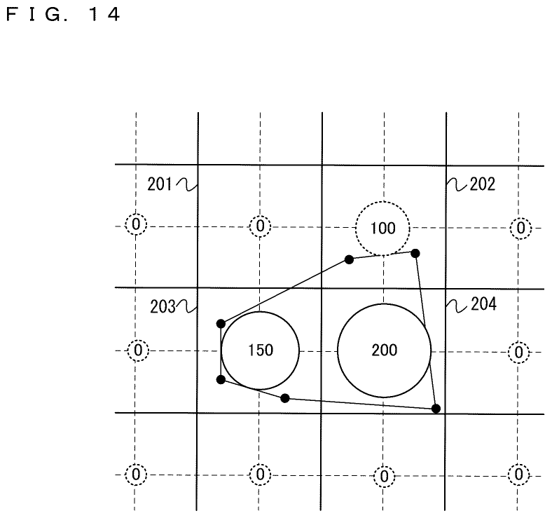

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. The terrain object shown in FIG. 8 is shown for the purpose of showing the relationship between voxels and voxel objects in an easy-to-understand manner. Note however that in the present embodiment, in practice, a voxel object is generated by such a rule (e.g., based on the voxel data) that results in a terrain object having a complicated shape in comparison with the cubic voxels, such as a terrain object shown in FIG. 15 to be described below, for example. Note that there is no limitation on the rule for determining the shape of the voxel object based on the voxel data. In other embodiments, the game system 1 may generate a voxel object as shown in FIG. 8 based on the object data or may generate a voxel object as shown in FIG. 15 based on the object data.

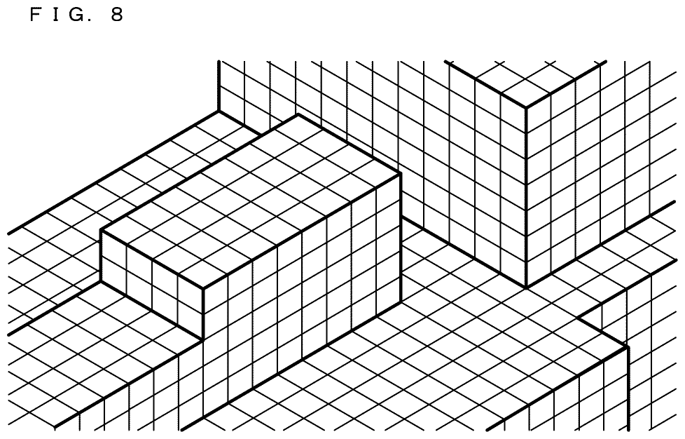

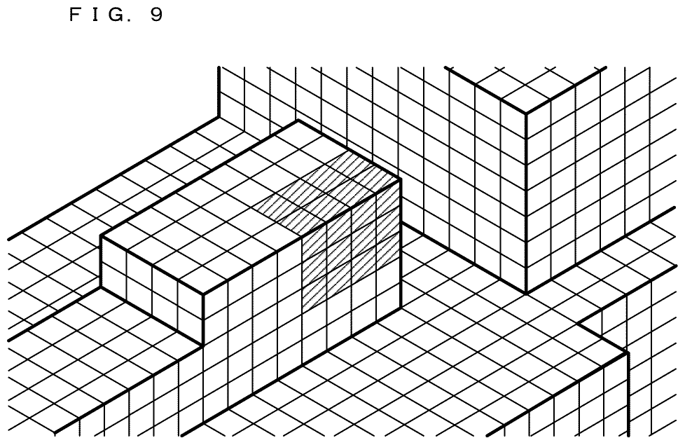

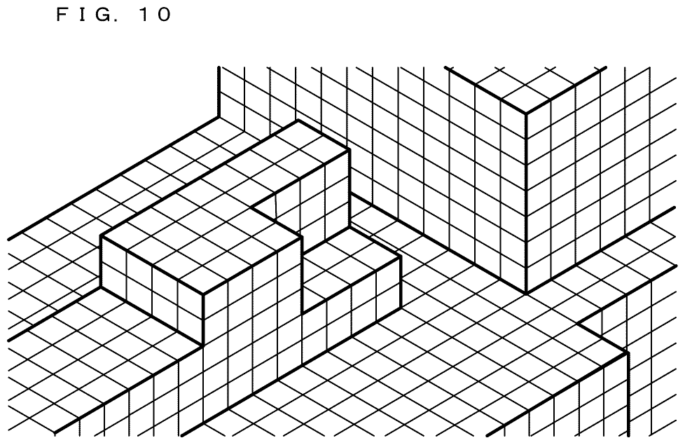

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting voxel data to be described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, when the shape of a terrain object may be changed as a result of the terrain object in a game being broken for some reason (e.g., the player character striking the terrain object), the game system 1 can freely change the shape of the terrain object by changing the voxel data used to generate the terrain object, rather than directly changing data representing the outer shape of the terrain object (e.g., the mesh to be described below).

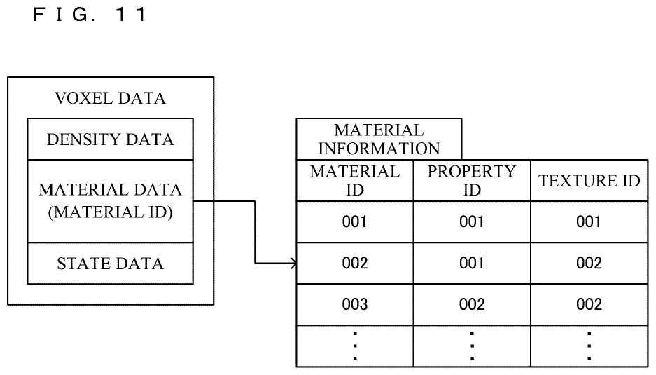

FIG. 11 is a diagram showing an example of content of voxel data. Here, in the present embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 11, voxel data includes density data. The density data represents a density that indicates the degree to which an object is included in a region defined by each voxel. As will be described in detail below, the position and the shape of the surface of the voxel object (e.g., the mesh to be described below) are determined based on this density. In other words, in the present embodiment, this density is also data that is used to generate a mesh that defines the surface of the voxel object.

In the present embodiment, the density can take an integer value in the range from the lower limit value (e.g., 0) to the upper limit value (e.g., 255). In the present embodiment, in the game system 1, the proportion of the volume to be occupied by the voxel object in a voxel tends to be higher when the density value set for the voxel is higher, and the proportion in a voxel tends to be lower when the density value is lower. For example, if the density is 0, there is no voxel object in the voxel, if the density is 255, the inside of the voxel is entirely the object, and if the density is between 0 and 255, the inside of the voxel is occupied by the object to the proportion that is determined based on the density value. Then, the shape of the voxel mesh, e.g., the shape of the voxel object, is determined based on the density. Note however that the shape of the voxel object generated based on the density does not need to have a volume that exactly matches the proportion represented by the density. For example, the method of generating a voxel object as shown in FIG. 8 and the method of generating a voxel object as shown in FIG. 15 may differ in the volume of the voxel object, even if they are based on the same density.

Note that in other embodiments, the density may indicate either a state in which the voxel object occupies the entirety of the region within the voxel or a state in which no voxel object is included in the region within the voxel. For example, the density data may be data that can take only one of 0 or 1.

As shown in FIG. 11, voxel data includes material data. The material data represents the material (e.g., the substance) of the voxel object generated by the voxel data. Here, in the present embodiment, materials such as sand, rock and soil, for example, are set for voxel objects. That is, in the present embodiment, a plurality of types of materials are provided as materials that can be set for a voxel object, and one of the materials is set for a voxel object.

As shown in FIG. 11, in the present embodiment, the material data represents the identification information of the material (referred to as “material ID”). In the present embodiment, the game system 1 stores material information representing the property and the texture of the material for each material provided in the game. In the present embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 11).

FIG. 12 is a diagram showing an example of property information representing properties of materials. As shown in FIG. 12, the game system 1 stores property information that associates each property ID with information that represents the content of the property represented by the property ID. A property of a material is a property of a voxel object for which the material is set in the game, and it may be information such as weight or slipperiness shown in FIG. 12, for example. Note that there is no limitation on the specific content of the property. For example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object

Note that there is no limitation on the specific content of the property to be set for a material. In other embodiments, information different from those listed above may be set as information that represents a property of a material.

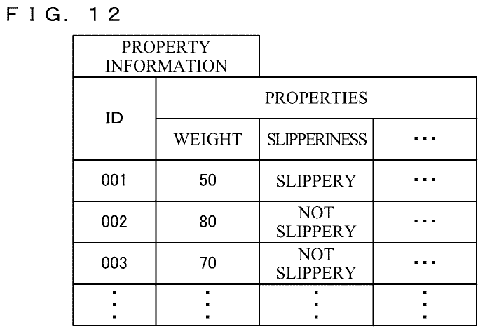

FIG. 13 is a diagram showing an example of texture information representing textures of materials. As shown in FIG. 13, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the present embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 11). In this case, the texture that is represented by the texture ID “002” associated with the material ID in the material information is applied to the voxel object corresponding to the voxel data (see arrow shown in FIG. 11).

As described above, in the present embodiment, the game system 1 separately manages the property and the texture of the material. Therefore, in the present embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 11, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

In the present embodiment, the surface of the voxel object is represented by a mesh. A mesh is a set of faces (specifically, polygons) placed in the game space. In the present embodiment, the game system 1 generates a mesh for the voxel object based on the voxel data of each voxel set in the game space. An example of how a mesh is generated based on voxel data will now be described.

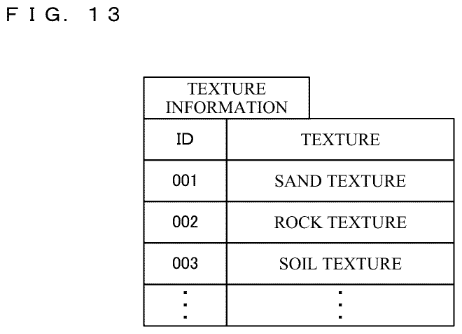

FIG. 14 is a diagram showing an example of a method for generating a mesh. Note that in FIG. 14, voxels and meshes are represented in two dimensions for the purpose of making the drawing easier to understand and for the sake of discussion, but in practice, a three-dimensional mesh is generated based on voxels in a three-dimensional space.

As described above, in the present embodiment, the density set for the voxel is in the range of 0 to 255. In the present embodiment, voxels with densities equal to or greater than the reference value are considered to be inside the voxel object, and voxels with densities less than the reference value are considered to be outside the voxel object. It is not necessary to define only voxels with a density of 0 as being outside the voxel object (e.g., reference value=1), and the reference value may be set to 128, for example. In the example shown in FIG. 14, a voxel 201 and the other outer voxels have a density of 0, a voxel 202 has a density of 100, which is less than the reference value, and voxels 203 and 204 have densities of 150 and 200, which are greater than the reference value. In the present embodiment, the game system 1 generates vertices between those voxels whose densities are equal to or greater than the reference value and those voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. Then, a polygon mesh is generated by connecting together adjacent vertices if the connection (the boundary between the regions including the vertices) passes through a voxel whose density is equal to or greater than the reference value and a voxel whose density is less than the reference value.

The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 14, the density of the voxel 202 is less than the reference value, the voxel 202 is treated as being outside the voxel object in the determination of the presence/absence of a vertex, but the density value itself of the voxel 202 is used to calculate the coordinates of the vertices generated. If the reference value were set to a value lower than the density of the voxel 202, it would result in an increase in the vertices on the upper right side and the upper left side in the voxel 202 of FIG. 14.

By generating a polygon mesh as described above, it is possible to generate a shape whose volume reflects the density of each voxel to some extent. Note however that depending on the relationship with neighboring voxels, it is possible that a voxel with a density of 0 may partially include a region inside the voxel object, or a voxel with a density of 255 may partially include a region outside the voxel object. Since voxels with densities less than the reference value are treated as being outside the voxel object in the present embodiment, there are fewer vertices as compared with a case where those voxels are treated as being inside the voxel object, the volume will be smaller accordingly. That is, there is no need to calculate the polygon mesh so that the volume strictly corresponds to the density value.

FIG. 15 shows an example of a game image including a terrain object. In the present embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel (see FIG. 8).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists.

Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

As described above, in the present embodiment, the game system 1 sets the color and/or pattern of the mesh of the voxel object based on appearance data (specifically, a texture ID representing a texture) that defines the color and/or pattern of the voxel object for each voxel. Specifically, for a mesh to be generated based on voxel data of a certain voxel, among meshes of voxel objects, the game system 1 applies the texture represented by the appearance data for the voxel to the mesh of the voxel object that is generated based on the voxel data for the certain voxel. Thus, it is possible to set the color and/or pattern of the voxel object using the appearance data set for the voxel.

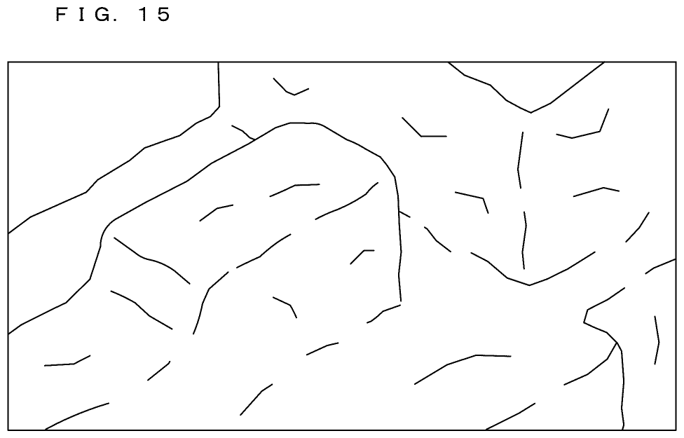

Next, an example of game play in which a player character is operated in a game space according to the user's operation performed on the game system 1 will be described with reference to FIGS. 16 to 21. For example, in the present example, a player character PC appearing in the game space displayed on the display 12 is operated according to the user's operation performed on the operation buttons and sticks of the left controller 3 and/or the right controller 4 of the game system 1 in the unified form, the user's touch operation performed on the touch panel 13 of the main body apparatus 2, the user's operation of moving the entire game system 1 or changing the orientation of the game system 1, and the like.

FIG. 16 is a diagram showing an example of a game image that is of a game space in which a terrain object TO and a player character PC are set, and that is displayed on the display 12. The terrain object TO is an example of a stage object included in a game stage in the game space. In the present example, the terrain object TO is formed of voxel objects that are generated based on the above voxel data, and a surface of which is represented by a mesh. For example, a voxel space in which voxels are specified is set in the game space, and the terrain object TO is generated in the game space by a plurality of voxels being specified in the voxel space. Here, at least one voxel space is set in at least a portion of the game space in order to specify a plurality of voxels. For each voxel space, the length (resolution) of an edge of a voxel, the vectors (orientations) of the x-, y-, and z-axes of a global coordinate system in a vector space, the length of the voxel space in each of the x-, y-, and z-directions, and a location of the voxel space in the game space, and the like are specified. Although FIG. 16 shows an example in which rendering is performed by generation of a mesh having an appearance as shown in FIG. 15 using the technique described with reference to FIG. 14, rendering may be performed using a block mesh described with reference to FIG. 9 or 10.

In the present example, at least a portion of the terrain object TO can be broken to disappear (to be removed) by the player character PC performing an action of breaking the terrain object TO. As an example, the terrain object TO can be broken such that a portion of the terrain object TO is removed, by the player character PC performing an action of hitting a portion of the terrain object TO.

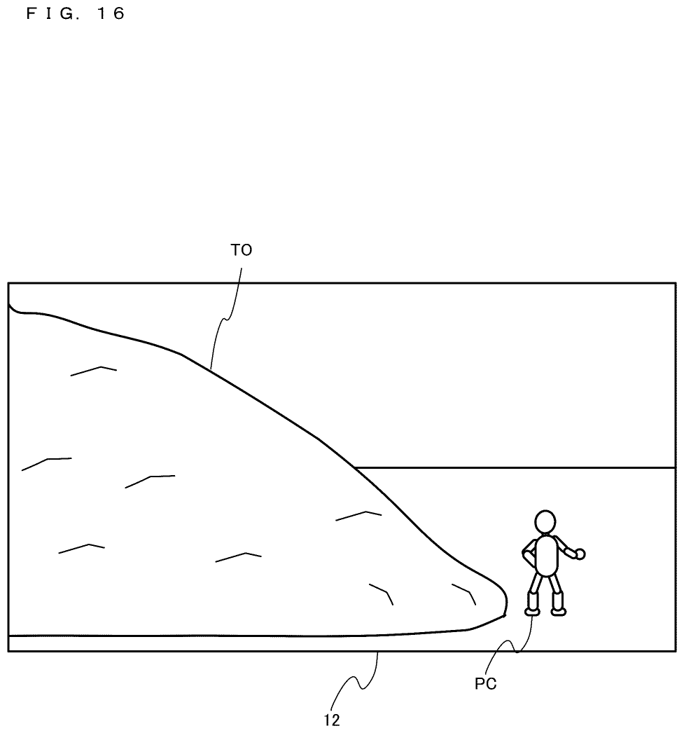

FIG. 17 is a diagram showing an example of a game image in which a portion of the terrain object TO has been removed by the player character PC. As an example, the game image of FIG. 17 shows the inside of the terrain object TO in which the player character PC is digging by removing a portion of the terrain object TO, using a vertical cross-sectional view of the terrain object TO, indicating a situation that the player character PC is digging.

When the player character PC performs an action of hitting a portion of the terrain object TO, a predetermined range of the terrain object TO around the hit portion is removed. For example, as shown in the upper figure of FIG. 17, when the player character PC performs an action of hitting a wall at the far end of a cave formed in the terrain object TO, a portion of the terrain object TO deeper than the wall is removed, so that excavation is proceeded in a depth direction in the cave. Specifically, as shown in the lower figure of FIG. 17, in the terrain object TO, a bell-shaped broken range is formed that is in the shape of a semi-ellipsoid at the deepest portion broken and removed by the breaking action performed by the player character PC. This action causes the space where the terrain object TO is absent to be extended at the deepest portion of the cave, and as a result, the amount of the terrain object TO that is present in the game space is changed. FIG. 17 shows an example in which the terrain object TO is reduced by a reduced amount CV due to the above action.

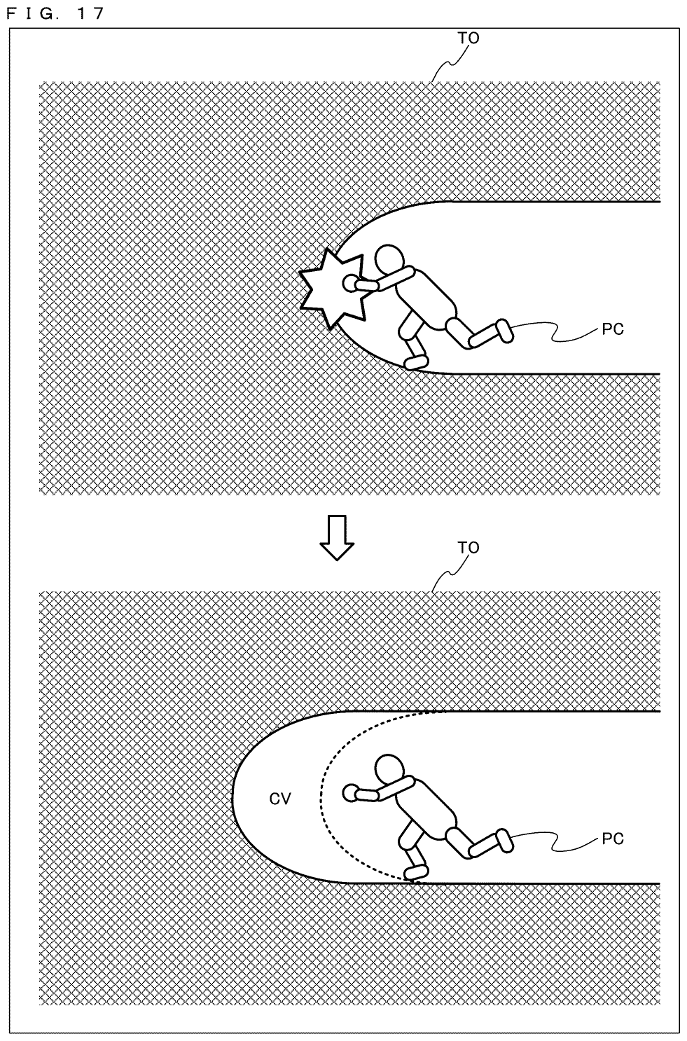

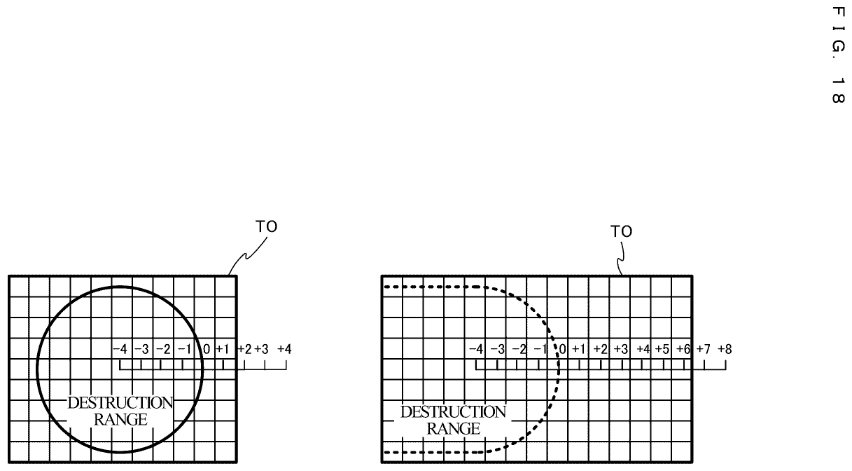

In the present example, by changing the voxel data of the voxels constituting the terrain object TO, the process of how the terrain object TO is broken and removed can be represented. FIG. 18 is a diagram showing an example of a destruction range of voxels to be broken in the terrain object TO. Note that the left figure of FIG. 18 shows the front surface (surface to be broken) of the terrain object TO as viewed from the player character PC, which breaks the terrain object TO. The right figure of FIG. 18 shows the right side surface of the terrain object TO shown in the left figure.

The destruction range of the terrain object TO to be broken by the player character PC's breaking action is set based on the location where the player character PC breaks the terrain object TO, the player character PC's strength and capability, and the strength (material) of the terrain object TO. For example, the destruction range is set such that a distance from a reference location set based on a location where the player character PC has performed a breaking action in the game space is within a predetermined distance. In the example of FIG. 18, for the terrain object TO, a bell-shaped destruction range having a semi-spherical shape at a deepest portion lost due to the destruction is formed around the location where the player character PC has performed a breaking action. Note that the shape of the destruction range may be other shapes such as a sphere, ellipsoid, cube, cylinder, wedge, shapes generated by 3D software, and in addition, these shapes a portion of which has been removed, and the like. The destruction range may be located around a location where the player character PC has performed a breaking action (e.g., a location where the player character PC's punching first has reached) in the game space, or around a place at a predetermined distance in front of that location as viewed from the player character PC.

A voxel to be removed (or partially removed) with reference to the above destruction range is determined using a signed distance field (SDF). The SDF of a voxel indicates a distance between the voxel and a surface of the destruction range closest to that voxel. It is assumed that the SDF of a voxel located on a surface of the destruction range is zero, the SDF of a voxel located outside the destruction range is positive, and the SDF of a voxel located inside the destruction range is negative. A removal process is set for each voxel, depending on the SDF of the voxel. For example, for a voxel to be removed, a portion of the terrain object TO that corresponds to the voxel is removed by rewriting the voxel data of the voxel such that the voxel data indicates the absence of a terrain object.

For example, in the present example, removal of at least a portion of a voxel is controlled by changing a density included in the voxel data thereof. For example, the density is an index indicating the proportion of the volume of a voxel object to a region defined by a voxel. The density can take an integer value in the range from the lower limit value (e.g., 0) to the upper limit value (e.g., 255). It is assumed that the higher the value of the density set for a voxel, the greater the proportion in the voxel, and the lower the value of the density, the smaller the proportion in the voxel. It is also assumed that no voxel object is included in a voxel the value of the density of which is the lower limit (e.g., 0), and a voxel object is included throughout a voxel the value of the density of which is the upper limit value (e.g., 255). In other words, if the value of the density is greater than the lower limit value, the voxel data indicates the presence of a terrain object, and if the value of the density is the lower limit value, the voxel data indicates the absence of a terrain object. Note that the shape of a voxel mesh generated based on the density does not need to have a volume exactly corresponding to the value of the density.

In the present example, removal of a voxel is controlled by rewriting the density of the voxel based on the SDF of the voxel. Specifically, by rewriting and reducing the densities of at least voxels having a negative SDF distance, at least a portion of the voxels included in the destruction range are changed to the state in which no terrain object is present. As a first example, by rewriting the densities of voxels having a negative SDF distance to the lower limit value, the voxels, which are included in the destruction range, are set to the state in which no terrain object is present, and by maintaining the values of the densities of voxels having a positive SDF distance unchanged, the voxels, which are out of the destruction range, are set to the state in which a terrain object is present. As a second example, by rewriting the densities of voxels having a negative SDF distance such that the value of the density of the voxel decreases with an increase in the absolute value of the distance, and rewriting the densities of voxels whose absolute value is greater than a predetermined value to the lower limit value, a portion of the voxels, which are included in the destruction range, are set to the state in which no terrain object is present, and by maintaining the values of the densities of voxels having a positive SDF distance unchanged, the voxels, which are out of the destruction range, are set to the state in which a terrain object is present. As a third example, by rewriting the densities of voxels having a negative SDF distance to the lower limit value, the voxels, which are included in the destruction range, are set to the state in which no terrain object is present, and by rewriting the densities of voxels having a positive SDF distance such that the value of the density of the voxel decreases with a decrease in the absolute value of the distance, a portion of the voxels, which are out of the destruction range, are set to the state in which the voxel is not entirely occupied by a voxel object.

Note that the density in the voxel data may be rewritten by adjusting the change amount of the density, depending on the type and state of a material indicated by material data included in the voxel data. For example, the change amount of the density may be adjusted (e.g., the change amount of the density to be rewritten is increased for a more breakable material), depending on a property (e.g., breakability or temperature) of a material indicated by the material data.

Alternatively, when the density in the voxel data is rewritten, the change amount of the density may be adjusted, depending on state data included in the voxel data. For example, the state data indicates the amount of damage applied to the terrain object TO by the player character PC. As an example, whether to reduce the density in the voxel data and whether to increase the amount of damage may be determined based on a relationship between the offensive strength of the player character PC and the defensive strength of the terrain object TO. Specifically, based on a relationship between the hardness of the offensive entity (e.g., the hardness of a first of the player character PC punching the terrain object TO) and the hardness of the defensive (attacked) entity (the hardness of the material of the terrain object TO), the density in the destruction range is rewritten if the hardness of the offensive entity is greater, and neither the density in the destruction range nor the amount of damage is rewritten if the hardness of the defensive (attacked) entity is greater. If the hardness of the offensive entity is substantially equal to the hardness of the defensive (attacked) entity, the amount of damage to voxels in the destruction range is increased, and if the amount of the damage exceeds the acceptable amount of the voxel (the damage endurance value of the material), the densities of the voxels are rewritten. Note that the amount of damage to a voxel exceeds the acceptable amount of the voxel, the density of the voxel may be set to zero, e.g., the voxel may be removed. Thus, the amount of damage to a voxel can serve as voxel data indicating the absence of a terrain.

After the density is rewritten as described above, a mesh is newly formed on a surface (specifically, a surface that is newly exposed to the outside by breaking) of the terrain object TO to update the display. For example, when an event occurs in which the terrain object TO is broken, a mesh is newly formed by recalculating mesh vertices in a range including voxels whose voxel data has been rewritten due to the destruction. As an example, as shown in FIG. 14, mesh vertices are generated. Thus, after voxels are removed, a new mesh may be generated between a voxel in which a terrain is absent and a voxel in which a terrain is present, by an algorithm that recalculates mesh vertices based on the densities of voxels, so that the terrain object TO may be removed. Thereafter, texture for use in rendering each face of the mesh is determined based on the voxel data, and the determined texture is mapped to each face, whereby an image of the broken terrain object TO is generated. Note that the range in which mesh recalculation is performed may be a chunk including voxels whose voxel data has been rewritten (a process unit including a predetermined number of voxels). For example, if a chunk includes 16×16×16 voxels, and recalculation is performed on chunks including voxels whose voxel data has been rewritten, processing can be reduced compared to when a mesh is recalculated throughout the game space. The range may be a voxel space in which voxels whose voxel data has been rewritten are located, or the entire terrain object TO, which includes voxels whose voxel data has been rewritten. If the processing load is not so great, a mesh may be recalculated throughout the game space.

In the present example, a placed object OBJ is placed in the game space, based on the reduced amount CV of the terrain object TO. As an example, the reduced amount CV is a value indicating a reduction in the volume of the terrain object TO obtained by the recalculation of the mesh (a value indicating how much the volume is reduced in the game space due to a change in the mesh, e.g., the total amount of changes in volume due to reductions in voxel objects). As another example, the reduced amount CV may be either the sum of the reduced amounts of the densities of the voxels constituting the terrain object TO, or the total number of voxels constituting the terrain object TO that have been removed or deformed. Note that the unit of removal of the terrain object TO is a continuous quantity that may be smaller than the amount occupied by a voxel. Therefore, in the case in which the reduced amount CV is calculated using a reduction in the volume of the terrain object TO obtained by mesh recalculation or the reduced amount of the densities of the voxels constituting the terrain object TO, the reduced amount CV may be a value smaller than the amount of a voxel associated with each piece of voxel data (e.g., the volume or density of a voxel fully filled with an object).

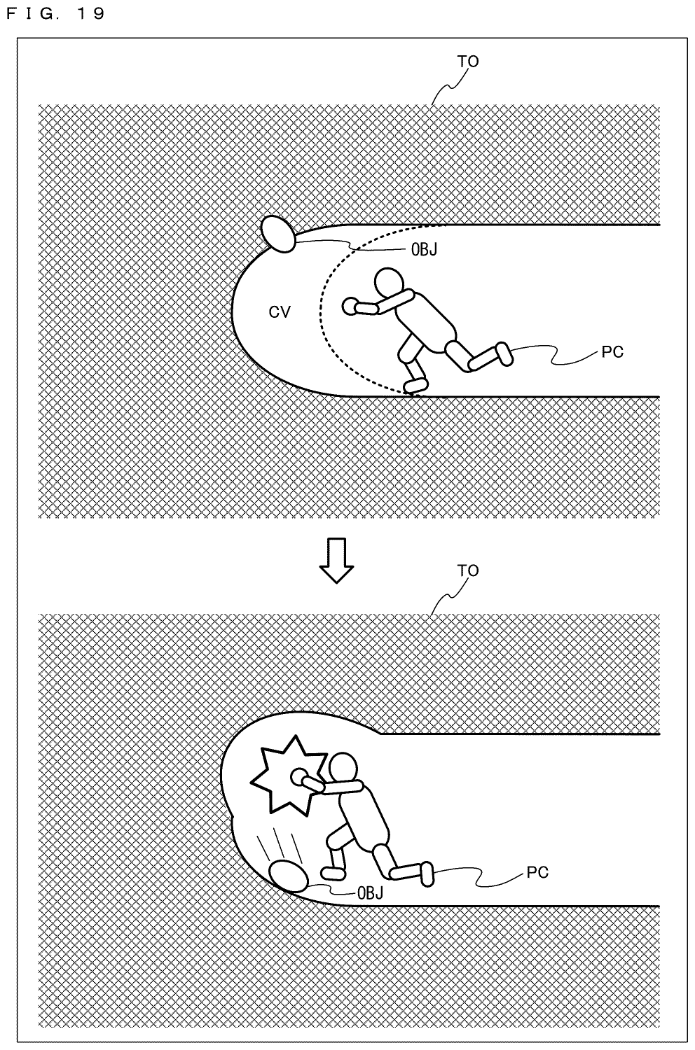

When the cumulative value of the reduced amount CV reaches a threshold, a placed object OBJ corresponding to the threshold is placed to newly appear in the game space. For example, as shown in the upper figure of FIG. 19, when the cumulative value of the reduced amount CV of the terrain object TO reaches a threshold, a placed object OBJ is newly placed in the vicinity of the location of removal of the terrain object TO. A placed object OBJ is different from stage objects such as a terrain object TO. Examples of a placed object OBJ include coins, recovery items, collection items, and the like that the player character PC desires to obtain or collect in a game, virtual objects such as fossils and treasure boxes obtained by excavation or exploration, and non-player characters. As a placed object OBJ is placed in the vicinity of the location of removal of the terrain object TO, the placed object OBJ is located in a direction in which a portion of the terrain object TO has been removed, as viewed from the player character PC. As used herein, the direction in which a portion of the terrain object TO has been removed refers to a direction in which the location of a surface of the terrain object TO has been reduced or moved to a greatest extent due to the removal of the terrain object TO.

As an example, a placed object OBJ is newly placed and buried in a surface of the terrain object TO in the vicinity of the location of removal of the terrain object TO, which is triggered when the cumulative value reaches a threshold. A placed object OBJ may be placed and buried in a surface of the terrain object TO with a portion thereof exposed from the surface, or may be completely buried in the terrain object TO in the vicinity of that surface. As another example, a placed object OBJ may be placed in a space formed due to removal of the terrain object TO. A plurality of placed objects OBJ may be placed at a surface of the terrain object TO in the vicinity of the location of removal of the terrain object TO all at once. In that case, as the number of placed objects OBJ that are placed all at once increases, the possibility of that occurrence may be set lower.

As another example, a placed object OBJ may be newly placed and buried in a surface of the terrain object TO in the vicinity of the location of removal of the terrain object TO, based on a possibility that increases, depending on the cumulative value. In that case, as the cumulative value increases, the possibility that a placed object OBJ is placed increases.

A placed object OBJ can be obtained by the player character PC performing an obtaining action such as touching. For example, as shown in the upper figure of FIG. 19, when a placed object OBJ appears, being buried in a surface of the terrain object TO, the placed object OBJ can be released from a buried state in which the placed object OBJ is buried in the terrain object TO, by the player character PC further removing a portion of the terrain object TO in which the placed object OBJ is buried. As used herein, “release from a buried state” refers to ending of the buried state of a placed object OBJ due to, for example, falling of the placed object OBJ buried in the terrain object TO to a stage (e.g., a surface of the terrain object TO newly formed by the player character PC removing the terrain object TO). As an example, as shown in the lower figure of FIG. 19, the terrain object TO supporting a placed object OBJ is removed by the player character PC performing an action of breaking the terrain object TO around the placed object OBJ, so that the buried state of the placed object OBJ buried in the terrain object TO is ended. When a placed object OBJ is released from the buried state in the terrain object TO, or the player character PC performs an action of obtaining the placed object OBJ after the release, the placed object OBJ is obtained by the player character PC. Note that, as another example, a placed object OBJ may be automatically obtained by the player character PC immediately after the placed object OBJ newly appears and is temporarily placed in the game space.

Thus, in the present example, a portion of the terrain object TO can be removed based on the user's operation input, and a placed object OBJ is placed and buried in a surface of the terrain object TO in the vicinity of the location of the removal, depending on the removal. Thereafter, when a portion of the terrain object TO where the placed object OBJ is buried is further removed based on the user's operation input, the placed object OBJ is released from the buried state. Therefore, in the present example, a placed object OBJ can be caused to appear by an operation input to remove the terrain object TO, and can be obtained by an additional operation input to remove the terrain object TO, which further improves the user's motivation for removing the terrain object TO.

When a placed object OBJ is placed, the cumulative value that has been calculated so far for placement of the placed object OBJ is reset to a predetermined initial value (e.g., 0), and the accumulation of the reduced amount CV is resumed from the initial value. Thereafter, when the cumulative value reaches the threshold again, a placed object OBJ corresponding to the threshold is caused to newly appear again in the game space as in the above appearance process. Therefore, the player character PC can regularly obtain a placed object OBJ by continuing an action of removing the terrain object TO.

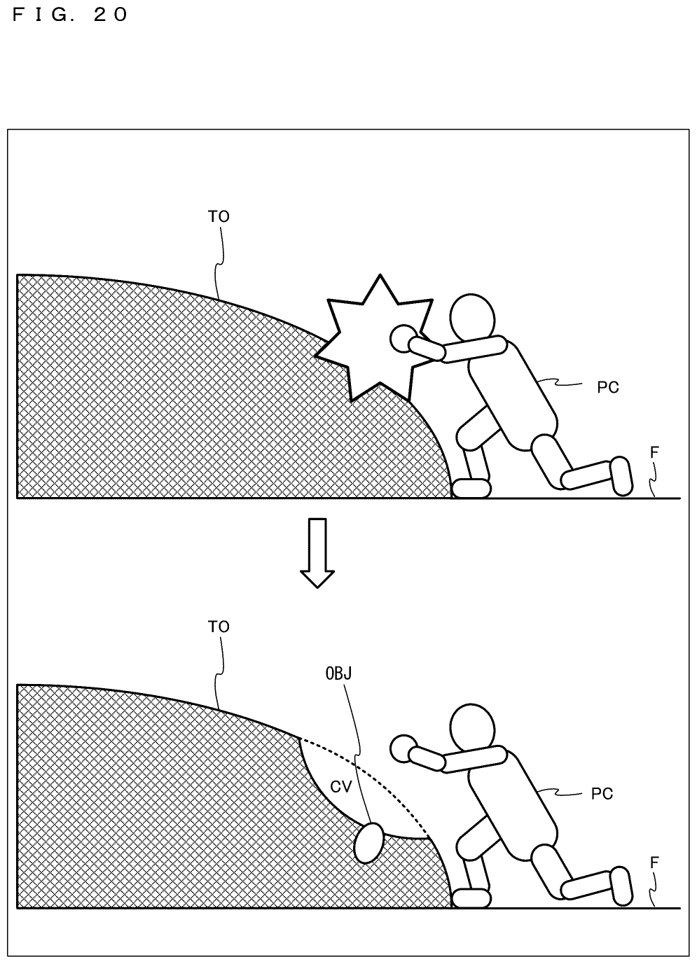

Note that when a space formed by removing the terrain object TO is open to the outside, a placed object OBJ may be placed at a location depending on an open state of the space. For example, as shown in FIG. 20, when a space in which the terrain object TO is absent is formed on the opposite side of the location of removal of the terrain object TO in the game space from the direction of gravity, a placed object OBJ may be placed closer to the direction of gravity in the game space than a direction in which the terrain object TO has been removed. By causing a placed object OBJ to appear at a location depending on an open state of a space thus formed, the placed object OBJ can be caused to appear at an appropriate location, which does not seem unnatural to the user.

A plurality of types of placed objects OBJ may be prepared. In that case, a cumulative value may be calculated for each type of placed object OBJ, and each time any of the cumulative values reaches a corresponding threshold (thresholds are set for the respective corresponding types of placed objects OBJ), a type of placed object OBJ corresponding to the reached threshold may be placed. The cumulative value for each type of placed object OBJ may be reset to a predetermined initial value in a manner similar to that described above when the placed object OBJ is placed. In the case in which a plurality of types of placed objects OBJ are prepared, different thresholds may be set for different types of placed objects OBJ, and a cumulative value may be calculated for each type of placed object OBJ.

In the case in which a cumulative value is calculated for each type of placed object OBJ, the different types of placed objects OBJ may have different incremental values with respect to the reduced amount CV. The cumulative values of the different types of placed objects OBJ may be reset to different initial values.

There may be a type of placed object OBJ that may or may not appear, depending on the direction in which the player character PC removes the terrain object TO. For example, a type of placed object OBJ that falls after appearing may be controlled so as not to appear when the player character PC removes the terrain object TO in an upward direction, in order to prevent the placed object OBJ from falling and striking the player character PC when appearing.

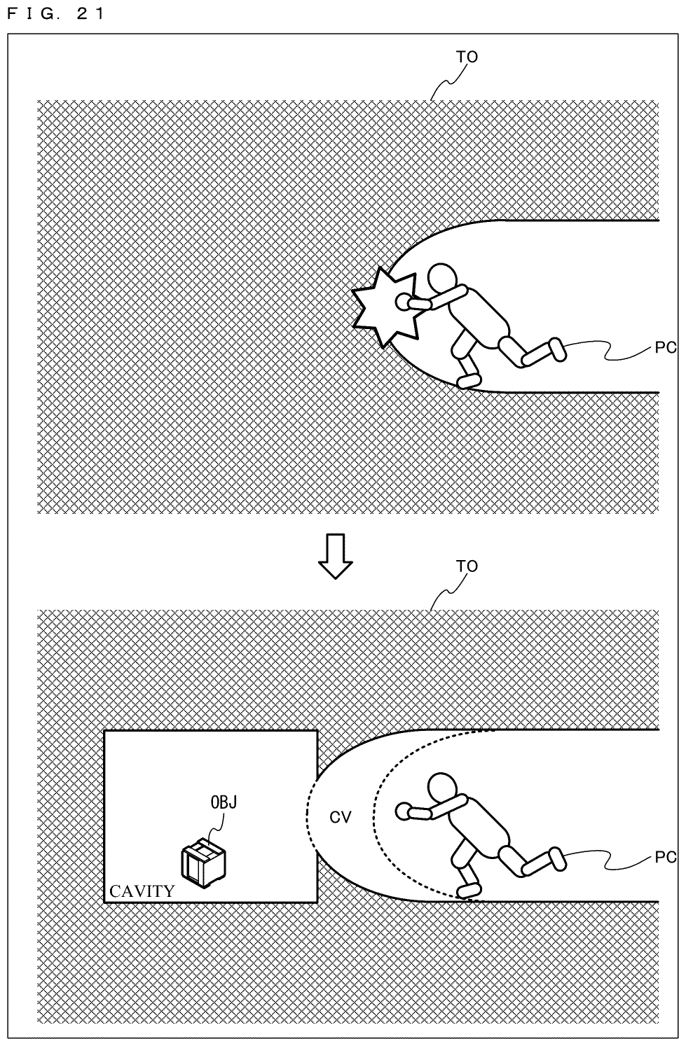

A placed object OBJ may be caused to appear in a space (e.g., a cavity) that is further formed, in addition to that which is formed by removal of the terrain object TO by the player character PC's breaking action. For example, as shown in FIG. 21, a cavity may be further formed in the terrain object TO in the vicinity of a removed portion of the terrain object TO, and a placed object OBJ may be caused to appear in the cavity. As an example, in an example shown in FIG. 21, a space (a range indicated by the reduced amount CV) formed by removal of the terrain object TO due to the player character PC's breaking action is present at a deepest portion of a cave, and in addition, another space (cavity) is present in front of that space formed by the removal. A placed object OBJ is newly provided in the cavity. Note that a placed object OBJ is placed in a cavity that is formed in the vicinity of a removed portion of the terrain object TO, and therefore, is placed in a direction in which a portion of the terrain object TO has been removed, as viewed from the player character PC.

A cumulative value is also calculated for a placed object OBJ to be placed in the cavity (and cavity formation), and when the cumulative value reaches a threshold, the cavity is formed, and the placed object OBJ is placed in the cavity. The cumulative value calculated for a placed object OBJ to be placed in the cavity is reset to a predetermined initial value when the cavity is formed and the placed object OBJ is placed. Note that when the cavity is formed in the terrain object TO, the terrain object TO is reduced by a volume corresponding to the cavity. This reduction in volume may not be added to a cumulative value being calculated, or may be added to each cumulative value.

Note that the cavity may be able to be formed only when the player character PC performs an action of breaking the terrain object TO in a forward/rearward direction or a leftward/rightward direction. For example, when the player character PC removes the terrain object TO in a downward direction (in the direction of gravity in the game space) or when the player character PC removes the terrain object TO in an upward direction (in a direction opposite to the direction of gravity in the game space), then even if a cumulative value for a placed object OBJ to be placed in the cavity reaches a threshold due to the removal, the cavity is not formed. In the case in which the cavity is not formed, because the removal direction is an upward/downward direction, a cumulative value being calculated for a placed object OBJ to be placed in the cavity may be maintained unchanged, or may be reset to a predetermined initial value or a value that is greater than the initial value. In the former case, even when the cavity is not formed, because of the removal direction, then if the removal direction is changed, the cavity may be immediately formed, resulting in an improvement in the response of the production process. In the latter case, even when the player character PC continues to perform a breaking action in a removal direction that does not contribute to formation of the cavity, it is not necessary to repeatedly determine whether or not formation of the cavity is allowed, resulting in a reduction in processing load. Note that even when the cavity is not formed, because the removal direction is an upward/downward direction, a different placed object OBJ that does not require formation of the cavity is allowed to be placed. Thus, a process determining whether to further form the cavity and place a placed object OBJ in the cavity, or place a placed object OBJ without further formation of the cavity, is performed, depending on the direction in which the terrain object TO has been removed.

When an attempt is made to form the cavity, then if there is not enough space in the terrain object TO to form the cavity, the cavity may not be formed, and a placed object OBJ to be placed in the cavity may not be placed. For example, when the quantity of the terrain object TO remaining around the player character PC is so small that the cavity cannot be formed in the terrain object TO, the cavity is not formed. Specifically, if it can be predicted that when a cavity is further formed in front of a deepest portion of a cave, the cavity will be open to the outside of the terrain object TO, the cavity is not formed. When the cavity is thus not formed, because there is not enough space to form the cavity, a cumulative value being calculated for a placed object OBJ to be placed in the cavity may be maintained unchanged, or may be reset to a predetermined initial value or a value that is greater than the initial value.

In the foregoing, as an example of an event in which the terrain object TO is removed, a portion of the terrain object TO is broken and removed due to the player character PC's breaking action hitting the terrain object TO, e.g., the player character PC punching the terrain object TO. The terrain object TO may also be removed due to other events. For example, in an event, the terrain object TO may be broken by being hit by the entire body or another part such as a leg of the player character PC, or by being hit by the player character PC with an item such as a weapon. In an event, the terrain object TO may also be broken by being hit by another object such as a rock thrown or kicked by the player character PC, or by being hit by a bullet object fired or launched by the player character PC, or the like. The terrain object TO may also be removed due to such events.

In the foregoing, as an example, the terrain object TO is removed by the player character PC's breaking action according to the user's operation input. The terrain object TO may also be removed by an operation input that is different from that for causing the player character PC to perform an action. For example, the terrain object TO may be broken and removed at a location pointed by the user with a pointer or the like, and a placed object OBJ may be caused to appear, depending on the reduced amount by which the terrain object TO has been removed. In that case, the player character PC may or may not appear in the game space. Even when the player character PC is present in the game space, the terrain object TO may be removed based on a location indicated by the user irrespective of the player character PC's action.

While a portion of the terrain object TO is removed by the player character PC performing a breaking action of breaking a portion of the terrain object TO, an effect scene may be displayed in which broken pieces of the broken terrain object TO fly in the air in the game space, and land on a surface of the terrain object TO. In that case, as the broken pieces are originally a portion of the terrain object TO, the volume of the broken pieces is not removed from the game space in strict sense, e.g., the broken pieces do not contribute to a reduction in the terrain object TO. However, the reduced amount CV may be calculated, assuming that the volume of the broken pieces is removed from the game space. In other words, in the present example, the reduced amount CV in the game space may be calculated, including the amount of broken pieces separated from the terrain object TO. Thus, even when a portion of the terrain object TO is separated, the separated portion of the terrain object TO is considered to be removed, and therefore, even in that case, a placed object OBJ can be caused to appear.

In the foregoing, as an example, the player character PC appears in the game space. A character different from the player character PC may also appear. For example, other characters such as an opponent character whose action in the game space is controlled by a processor may also appear, and a portion of the terrain object TO may be able to be removed by other characters' action. In that case, the reduced amount of the terrain object TO due to other characters' action may not be used in calculation of the cumulative value. A portion of the terrain object TO may also be removed (deformed) due to environmental changes or the like in the game space such as application of vibrations caused by an earthquake, or crushing power caused by striking wavefront or wind and rain, deterioration caused by exposure to outdoor air, or decomposition, independently of the player character PC's action or other characters' action. In that case, the reduced amount of the terrain object TO due to the environmental change may not be used in calculation of the cumulative value.

Other characters may be caused to appear in the game space in a manner similar to that for a placed object OBJ, depending on removal of the terrain object TO. In that case, if, when the player character PC removes the terrain object TO below the player character PC, another character is caused to appear below the player character PC, the player character PC may collide with the second character to suffer or inflict damage. In order to avoid such damage, no other characters may be caused to appear, when the player character PC removes the terrain object TO below itself.

Different processes may be executed according to attribute information of the terrain object TO to be processed. As described above, the reduced amount CV may be varied with respect to the same breaking action according to properties of a material indicated by attribute information of a voxel object. In the present example, as a first example, the incremental amount of the cumulative value may be varied with respect to the same reduced amount CV according to attribute information. For example, in the first example, when a voxel object for which it is necessary to perform an operation input for removal many times and that is therefore difficult to break (e.g., a relatively hard voxel object) is removed, the incremental amount of the cumulative value may be relatively increased. As an example, the incremental amount of the cumulative value may be varied according to the hardness of a material for a voxel object. When a voxel object having such a hardness that it is necessary to perform a breaking action three times in order to break the voxel object is broken, the incremental amount is tripled to calculate the cumulative value. Even when a voxel object having that hardness is broken by performing a special action once, the incremental amount is tripled to calculate the cumulative value. Note that in the above example, for some voxel objects, the special action may be the only action that can break the voxel objects. In that case, when such a voxel object is broken by the special action, the incremental amount of the cumulative value is set relatively great.

As a second example, a placed object OBJ may or may not be caused to appear, depending on attribute information of the terrain object TO in the vicinity of the location of removal. For example, when attribute information of the terrain object TO in the vicinity of the location of removal indicates properties of a material that does not allow a placed object OBJ to be placed therein or thereon such as water, feathers, or magma, or properties of a material that inflicts damage to the player character PC when the player character PC touches the material, and that does not allow a placed object OBJ to be extracted even when the placed object OBJ is placed in or on the material, a placed object OBJ cannot be placed in or on a surface of a voxel object having such a material. In that case, even when a terrain object TO of the above material is removed, the cumulative value may not be increased, or even when the cumulative value reaches a threshold that allows a placed object OBJ to appear due to removal of the terrain object TO, a placed object OBJ may not be placed in or on a surface of a voxel object having the material. In the latter case, the cumulative value being calculated may be maintained unchanged, or may be reset to a predetermined initial value or a value greater than the initial value.

In the foregoing, the terrain object TO is used as an example of an object that is partially removed from the game space. Other stage objects made of voxel objects may, of course, be partially removed from the game space by a similar process. For example, even when other stage objects made of voxel objects such as buildings, trees, items, and things provided in the game space are partially removed, a placed object OBJ can be caused to appear by a similar process. Even in the case in which any stage object is used, a different process may be executed according to attribute information of a stage object to be processed as described above.

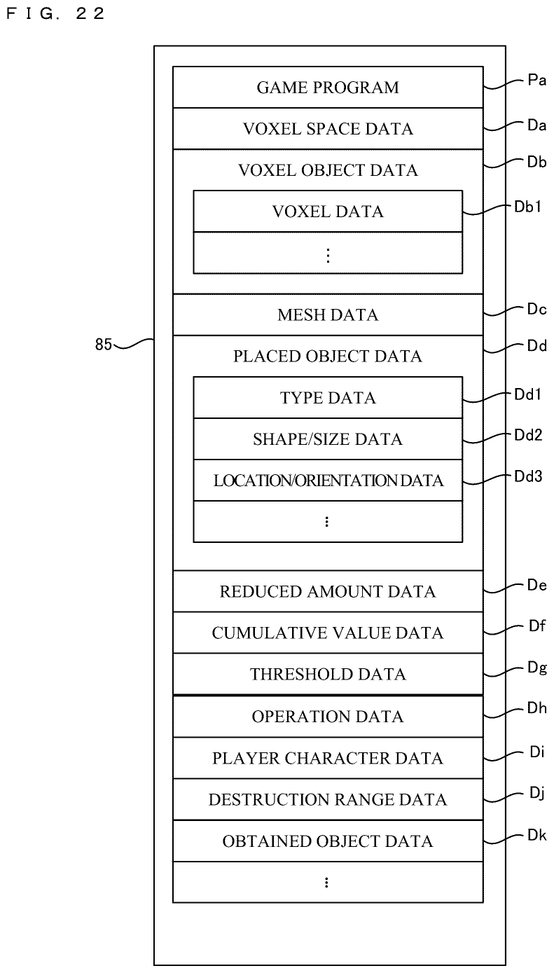

Next, a specific example of an information process of the game system 1 will be described with reference to FIGS. 22 to 24.

FIG. 22 is a diagram showing an example of various types of data used in an information process executed in the game system 1. As shown in FIG. 22, the game system 1 stores a game program Pa, voxel space data Da, voxel object data Db, mesh data Dc, placed object data Dd, reduced amount data De, cumulative value data Df, threshold data Dg, operation data Dh, player character data Di, destruction range data Dj, obtained object data Dk, and the like. The game program Pa and the voxel space data Da are previously stored in the game system 1 before a game process is executed. The game program Pa and the voxel space data Da are, for example, stored in a storage medium attached to the slot 23 of the main body apparatus 2. The voxel object data Db, mesh data Dc, placed object data Dd, reduced amount data De, cumulative value data Df, threshold data Dg, operation data Dh, player character data Di, destruction range data Dj, and obtained object data Dk are generated during execution of a game process. The voxel object data Db, mesh data Dc, placed object data Dd, reduced amount data De, cumulative value data Df, threshold data Dg, operation data Dh, player character data Di, destruction range data Dj, and obtained object data Dk are, for example, stored into the DRAM 85 of the main body apparatus 2.

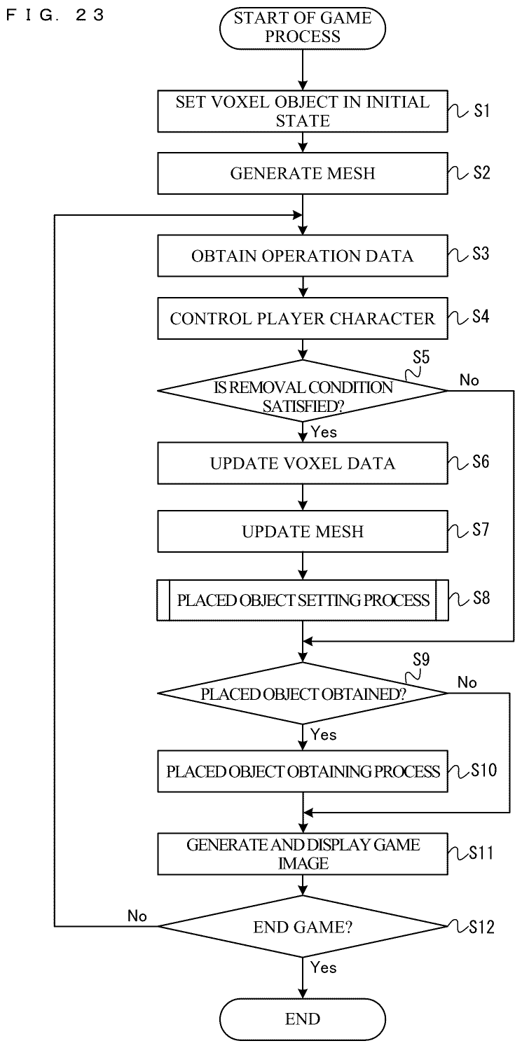

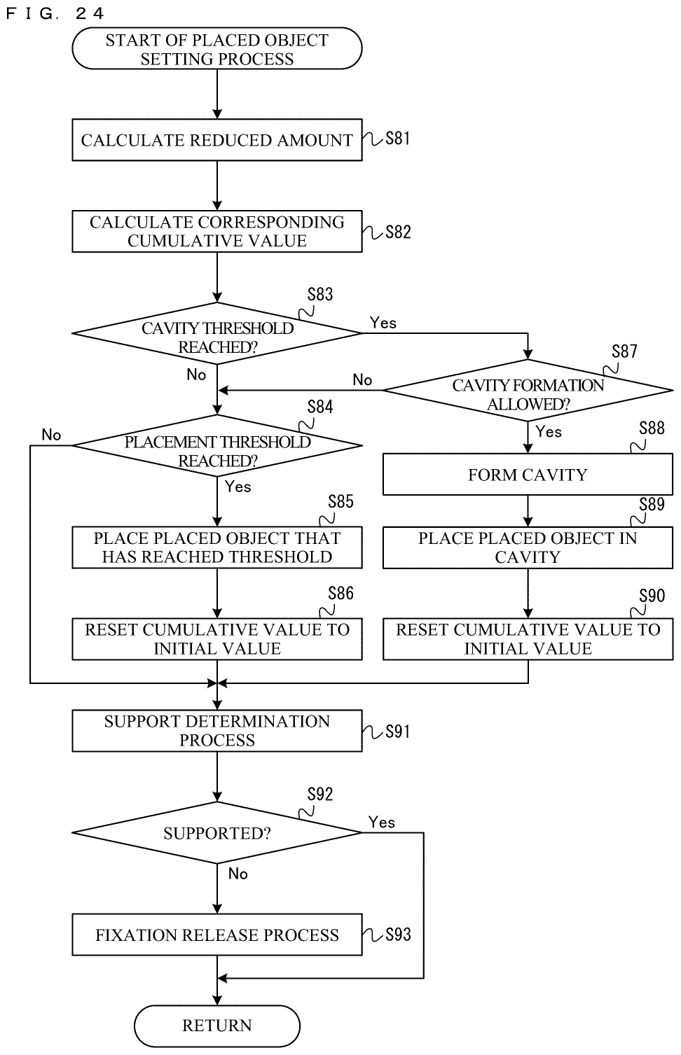

The game program Pa is for executing a game process (specifically, the game process shown in FIGS. 23 and 24) of the present example.

The voxel space data Da specifies voxels that are set in the game space. Specifically, the voxel space data Da indicates the length of an edge of each voxel, and the orientation of each edge of the voxel in the game space. In the case in which voxels are set only in part of the game space, the voxel space data Da includes data indicating the location and size of a space in which voxels are set (e.g., a voxel space) (e.g., data indicating a range of the game space in which voxels are set).

The voxel object data Db indicates a voxel object that is provided in the game space. Specifically, the voxel object data Db includes voxel data Db1 for each unit region in all or part of the game space.

The mesh data Dc indicates a mesh that is set for a voxel object which is provided in the game space. The mesh data Dc includes, for example, data indicating the vertices of a mesh.

The placed object data Dd indicates a placed object that is placed in the game space. Specifically, the placed object data includes type data Dd1, shape/size data Dd2, location/orientation data Dd3, and the like. The type data Dd1 indicates a type of a placed object. The shape/size data Dd2 indicates a shape and size of a placed object. The location/orientation data Dd3 indicates a location and orientation of a placed object that is provided in the game space.

The reduced amount data De indicates a reduced amount (a value indicating a reduction in the amount present in the game space) of a terrain object TO in the game space.

The cumulative value data Df indicates a value obtained by accumulating a reduced amount of a terrain object TO for each placed object or each cavity that is newly formed.

The threshold data Dg indicates a threshold set for each placed object that is caused to appear or each cavity that is newly formed.

The operation data Dh is obtained, as appropriate, from each of the left controller 3 and/or the right controller 4 and the main body apparatus 2. As described above, the operation data Dh obtained from each of the left controller 3 and/or the right controller 4 and the main body apparatus 2 includes information about an input from each input section (specifically, each button, an analog stick, or a touch panel) (specifically, information about an operation). In the present example, data is obtained from each of the left controller 3 and/or the right controller 4 and the main body apparatus 2. The obtained data is used to update the operation data Dh as appropriate. Note that the operation data Dh may be updated for each frame that is the cycle of a process (to be described below) executed in the game system 1, or may be updated each time operation data is obtained.

The player character data Di indicates the place and position of the player character PC placed in the virtual space, the movement and state in the virtual space of the player character PC, and the like.

The destruction range data Dj indicates a destruction range that is set when a terrain object TO is broken by the player character PC.

The obtained object data Dk indicates a placed object obtained by the player character PC.

Note that in addition to the data shown in FIG. 22, the game system 1 stores, for example, data of the above property information and texture information as data that is previously stored in the game system 1 before a game process is executed.

FIG. 23 is a flowchart showing an example of a flow of a game process that is executed in the game system 1. FIG. 24 is a subroutine showing an example of a placed object setting process of step S8 in the flowchart of FIG. 23. In the present example, a series of steps shown in FIGS. 23 and 24 are executed by the processor 81 executing the game program. The game processes of FIGS. 23 and 24 are started with any suitable timing. As an example, the game processes of FIGS. 23 and 24 are started according to an instruction to start a game that is provided by the user during execution of the game program.

Note that in the present embodiment, it is assumed that the processor 81 of the main body apparatus 2 executes the game program stored in the game system 1 to execute each step of FIGS. 23 and 24. Note that in another exemplary embodiment, a portion of the steps may be executed by a processor (e.g., a dedicated circuit) other than the processor 81. In the case in which the game system 1 can communicate with another information processing device (e.g., a server), a portion of the steps of FIGS. 23 and 24 may be executed by the information processing device. In other words, the steps of FIGS. 23 and 24 may be executed by a plurality of information processing devices including the main body apparatus 2 working together. The steps of FIGS. 23 and 24, which are merely for illustrative purposes, may be executed in a different order, or another step may be executed in addition to (or instead of) each step, if a similar effect is obtained.

The processor 81 executes the steps of FIGS. 23 and 24 using a memory (e.g., the DRAM 85). Specifically, the processor 81 stores information (e.g., data) obtained in each process step into a memory, and reads and uses the information from the memory when the information is required in a subsequent process step.

In FIG. 23, the processor 81 sets a voxel object in an initial state in the game space (step S1), and proceeds to the next step. Specifically, the processor 81 obtains voxel data indicating the arrangement of a voxel object in an initial state, and stores (e.g., writes) all or a portion of the obtained voxel data as the voxel object data Db into the DRAM 85. Note that the voxel data indicating the arrangement of a voxel object in an initial state is, for example, stored in a storage medium attached to the slot 23 of the main body apparatus 2.

Note that voxel data that is written as the voxel object data into the DRAM 85 may be voxel data corresponding to a partial range that is used in generation of a game image, of the voxel data corresponding to the entire range of the game space. For example, the processor 81 may generate an image of an object using voxel data corresponding to only a partial range of the game space (e.g., a range within a predetermined distance from the location of a virtual camera). In that case, the voxel object data Db may include voxel data within that range. When voxel data corresponding to a partial range of the game space is written, a process similar to step S1 is executed with appropriate timing (e.g., at a timing when the location of the virtual camera is moved by at least a predetermined distance) during execution of steps S4 to S12 to be described below.

Next, the processor 81 generates a mesh for the voxel object (step S2), and proceeds to the next step, in which the processor 81 starts a game, and repeatedly executes steps S3 to S12 in the game. A mesh is generated by the above method. Here, the processor 81 generates a mesh based on the voxel object data stored in the DRAM 85. As a result of step S2, a voxel object such as a terrain object TO is constructed in the game space.

Next, the processor 81 obtains data corresponding to the user's operation from the left controller 3, the right controller 4, and/or the main body apparatus 2, updates the operation data Dh (step S3), and proceeds to the next step.

Next, the processor 81 controls an action of the player character PC appearing in the game space (step S4), and proceeds to the next step. For example, the processor 81 controls the player character PC's action based on the operation data obtained in step S3, and updates the player character data Di. When, in addition to the player character PC, another character is placed, the processor 81 also controls that character's action based on an algorithm specified in the game program.

Next, the processor 81 determines whether or not a removal condition for removal of at least a portion of the voxel object is satisfied (step S5). For example, if the player character PC has hit the terrain object TO, the processor 81 sets a location where the terrain object TO has been hit and a surrounding range as a destruction range, updates the destruction range data Dj, breaks the terrain object TO (voxel object) present within the destruction range, and removes the broken portion. As an example, in order to represent a state that the destruction range has been broken, the densities indicated by the voxel data of at least a portion of the voxels included in the destruction range are set to zero, whereby the terrain object TO in the destruction range is removed. Therefore, if a voxel(s) of the voxel object is included in the destruction range hit by the player character PC, the result of the determination by the processor 81 is step S5 is positive. If the removal condition is satisfied, the processor 81 proceeds to step S6. Otherwise, i.e., if the removal condition is not satisfied, the processor 81 proceeds to step S9.

In step S6, the processor 81 updates the voxel data related to the voxel object that satisfies the removal condition, and proceeds to the next step. For example, in order to remove at least a portion of the voxel object that satisfies the removal condition, the processor 81 changes the densities of voxels in a portion hit by the player character PC and a surrounding portion, and updates the voxel data Db1 corresponding to each voxel. The processor 81 reduces the densities of voxels around the destruction range to be removed (e.g., a range affected by the hit) (provided that the reduced density is at least zero), and thereby removes the terrain object TO from the voxels around the destruction range. Specifically, the processor 81 updates the voxel object data Db stored in the DRAM 85 such that the density data is changed for the voxel data of the voxels in the range to be removed and a surrounding portion. Note that the processor 81 may update the density data such that the density indicates a value less than the reference value. For example, the processor 81 may set the densities of voxels in a portion (destruction range) hit by the player character PC to zero, and may reduce the densities of voxels in a surrounding region by a predetermined value.

Next, in step S7, the processor 81 updates the mesh for the voxel object whose voxel data has been changed in step S6, and proceeds to the next step. Specifically, the processor 81 generates a mesh for the voxel object that satisfies the removal condition, based on the voxel object data Db updated in step S6. Thus, a mesh for the terrain object TO can be dynamically changed in a game. Note that the processor 81 updates the mesh data Dc stored in in the DRAM 85 such that the mesh data indicates the newly generated mesh.

Next, the processor 81 executes a placed object setting process (step S8), and proceeds to step S9. The placed object setting process of step S8 will be described below with reference to FIG. 24.

In FIG. 24, the processor 81 calculates a reduced amount of the terrain object TO that has been changed due to updating of the voxel data in step S6 and/or updating of the mesh in step S7 (step S81), and proceeds to the next step. As an example, the processor 81 calculates a reduced amount (e.g., the reduced amount CV of FIG. 17) that is a reduction in the volume of the terrain object TO that is caused due to updating of the mesh in step S7 (the total amount of changes in volume of voxel objects), and updates the reduced amount data De.

Next, the processor 81 calculates a cumulative value (step S82), and proceeds to the next step. For example, the processor 81 adds the reduced amount calculated in step S81 to a cumulative value set for each placed object OBJ or each cavity that is to be newly formed, and updates the cumulative value data Df using the resultant cumulative value. Note that as described above, in the process of step S82, for the same reduced amount CV, the incremental amount of the cumulative value may be varied according to attribute information set for a removed voxel.

Next, the processor 81 determines whether or not a cumulative value managed for a cavity that is to be newly formed has reached a threshold (cavity threshold) for formation of the cavity, based on the cumulative value data Df and the threshold data Dg (step S83). If the cumulative value has not reached the cavity threshold, the processor 81 proceeds to step S84. Otherwise, i.e., if the cumulative value has reached the cavity threshold, the processor 81 proceeds to step S87.

In step S84, the processor 81 determines whether or not the cumulative value managed for each placed object OBJ has reached a corresponding threshold (placement threshold) for allowing the placed object OBJ to appear, based on the cumulative value data Df and the threshold data Dg. If any of the cumulative values has reached the corresponding placement threshold, the processor 81 proceeds to step S85. Otherwise, i.e., if none of the cumulative values has reached the corresponding placement threshold, the processor 81 proceeds to step S91. Note that attribute information of the terrain object TO in the vicinity of the location of removal indicates a material that does not allow a placed object OBJ to appear, the result of the determination in step S84 is negative.

In step S85, the processor 81 places a placed object OBJ for which a cumulative value has reached a placement threshold, and proceeds to the next step. For example, the processor 81 places a placed object OBJ for which a cumulative value has reached a placement threshold, in a predetermined orientation, such that the placed object OBJ appears in the vicinity of a location where the terrain object TO has been removed, and updates the placed object data Dd. As an example, the processor 81 places a placed object OBJ by burying the placed object OBJ in a surface of the terrain object TO exposed due to removal of the terrain object TO.

Next, the processor 81 changes the cumulative value that it is determined in step S84 has reached a placement threshold to an initial value, updates the cumulative value data Df (step S86), and proceeds to step S91.

Otherwise, i.e., if it is determined in step S83 that a cumulative value managed for a cavity has reached a cavity threshold, the processor 81 determines whether or not a cavity can be formed (step S87). For example, if there is not enough space in the terrain object TO to form a cavity or if the terrain object TO has been removed in an upward/downward direction by the player character PC, the result of the determination by the processor 81 in step S86 is negative. If a cavity can be formed, the processor 81 proceeds to step S88. Otherwise, i.e., if a cavity cannot be produced, the processor 81 proceeds to step S84.

In step S88, the processor 81 further forms a cavity in the terrain object TO, and proceeds to the next step. For example, in order to newly form a predetermined space in front of the location of removal by the player character PC, the processor 81 updates the voxel data of voxel objects present in that space, updates a mesh for the voxel objects whose voxel data has been changed, and updates the voxel object data Db and the mesh data Dc. Note that the voxel data and mesh are updated in a manner similar to that of steps S6 and S7 for voxels satisfying the removal conditions, which is not here described in detail.

Next, the processor 81 places a placed object OBJ prepared to be placed in a cavity, in the cavity produced in step S88 (step S89), and proceeds to the next step. For example, the processor 81 places a placed object OBJ in a predetermined orientation such that the placed object OBJ appears in the vicinity of a center of a bottom surface of the newly formed cavity, and updates the placed object data Dd.

Next, the processor 81 changes the cumulative value that it is determined in step S87 has reached a cavity threshold, to an initial value, updates the cumulative value data Df (step S90), and proceeds to step S91.

In step S91, the processor 81 executes a support determination process, and proceeds to the next step. For example, the processor 81 determines a supported state of a placed object OBJ buried in the terrain object TO, based on a proportion (coverage) of the placed object OBJ covered by the terrain object TO, a positional relationship between the center-of-gravity position and an exposed portion of the placed object OBJ, or the like.

Next, the processor 81 determines whether or not the placed object OBJ is buried and supported in the terrain object TO, based on the support determination process of step S91 (step S92). If the placed object OBJ is not supported in the terrain object TO, the processor 81 proceeds to step S93. Otherwise, i.e., if the placed object OBJ is buried and supported in the terrain object, the processor 81 ends the subroutine.

In step S93, the processor 81 executes a process of releasing fixation of the placed object OBJ that it is not determined is supported, and ends the subroutine. For example, the processor 81 releases fixation of the placed object OBJ buried in the terrain object TO, causes the placed object OBJ to fall from the placed location according to a physical law set in the game space, and updates the placed object data Dd. Note that in the case in which a placed object OBJ whose fixation has been released is automatically obtained by the player character PC, the placed object OBJ may be removed from the game space by executing a process involved with the obtaining, without providing a scene of the above falling movement in step S93.

Referring back to FIG. 23, in step S9, the processor 81 determines whether or not the player character PC has obtained a placed object OBJ. For example, if the player character PC satisfies a condition for obtaining a placed object OBJ (the player character PC touches a placed object OBJ, etc.), the result of the determination by the processor 81 in step S9 is positive. If the player character PC has obtained a placed object OBJ, the processor 81 proceeds to step S10. Otherwise, i.e., if the player character PC has not obtained a placed object OBJ, the processor 81 proceeds to step S11.

In step S10, the processor 81 executes a placed object obtaining process, and proceeds to step S11. For example, the processor 81 provides a setting that the player character PC possesses a placed object OBJ satisfying the obtaining condition, and updates the obtained object data Dk. The processor 81 also removes the placed object OBJ that has been obtained and possessed by the player character PC from the game space, and updates the placed object data Dd.

In step S11, the processor 81 generates a game image of the game space, displays the game image on a display device, and proceeds to the next step. Specifically, the processor 81 generates a game image of the game space including voxel objects (the terrain object TO), a placed object OBJ, and other objects (e.g., the player character PC and other characters), based on the voxel space data Da, the voxel object data Db, the mesh data Dc, the placed object data Dd, the player character data Di, and the like. Note that an image of voxel objects is generated by the above method using the voxel object data Db and the mesh data Dc. An image of a placed object OBJ is generated based on the placed object data Dd. An image of the player character PC is generated using the player character data Di. Thereafter, the processor 81 displays the generated game image on a display device. Note that in a game, step S11 is repeatedly executed at a rate of once per predetermined time (e.g., one frame time).

Next, the processor 81 determines whether or not to end the game (step S12). In step S12, the game process is ended, for example, if a condition for ending the game process is satisfied, the user has performed an operation of ending the game process, or the like. If the processor 81 does not determine to end the game process, the processor 81 returns to step S3, and repeats the process. Otherwise, i.e., if the processor 81 determines to end the game process, the processor 81 ends the flowchart. Following this, steps S3 to S12 are repeated executed until the processor 81 determines to end the game process in step S12.

Thus, in the present example, when the player character PC performs an action of removing the terrain object TO, a placed object OBJ newly appears. Therefore, the user's motivation for removing a stage object can be improved. In the case in which a placed object OBJ is caused to appear at random, an encounter with the appearance is probabilistic, and therefore, continuation of the removing action does not guarantee the appearance of a placed object OBJ, which may frustrate the user. However, in the present example, the appearance is not probabilistic, and a placed object OBJ appears when a reduction in volume (the cumulative value of reduced amounts) reaches a threshold, and therefore, such a probabilistic situation can be avoided. Furthermore, when placed objects OBJ are previously placed in the game space, data corresponding to all of the placed objects OBJ needs to be always managed, resulting in a relatively heavy processing load. In the present example, however, a placed object OBJ is caused to appear, depending on the removed amount of the terrain object TO, and therefore, the load of a process for managing data corresponding to placed objects OBJ can be reduced.

In addition, in the present example, a game creator does not need to previously manually place a placed object OBJ or a cavity at a place in any stage object (terrain object TO), and a placed object OBJ and a cavity can be caused to appear when the player character PC only continues to remove a stage object. Therefore, the cost of production can be reduced. In addition, each time the user plays a game, a placed object OBJ or a cavity may appear at a different place, resulting in promotion of a change in the user's game play.

In the foregoing, as an example, a stage object (terrain object TO) is specified by a three-dimensional mesh generated based on voxel data set for voxels in a three-dimensional space. Alternatively, a stage object may be specified based on voxel data set for two-dimensional voxels. For a stage object thus specified using two-dimensional voxels in a two-dimensional game world, a similar effect can be obtained by using, as a reduced amount, a reduction in the area or the like of a stage object caused by the player character PC performing an action of removing the stage object in the game world.

In addition, a stage object in which a placed object OBJ newly appears based on a reduced amount caused by removal may not be a voxel object. Even in the case in which at least a portion of a stage object set based on another data form such as a polygon is removed, a similar effect can be obtained by using a reduced amount of a stage object caused by the player character PC performing an action of removing the stage object in the game world.

The game system 1 may be any suitable apparatus, including a handheld game apparatus, or any suitable handheld electronic apparatus (a personal digital assistant (PDA), mobile telephone, personal computer, camera, tablet computer, etc.), etc. In that case, an input apparatus for performing an operation of causing a player object PC to perform an action may be, instead of the left controller 3 or the right controller 4, another controller, mouse, touchpad, touch panel, trackball, keyboard, directional pad, slidepad, etc.

In the foregoing, the information processes are performed in the game system 1. Alternatively, at least a portion of the process steps may be performed in another apparatus. For example, when the game system 1 can also communicate with another apparatus (e.g., another server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above non-limiting example, the information processes can be performed by the processor 81 of the game system 1 executing predetermined programs. Alternatively, all or a portion of the above processes may be performed by a dedicated circuit included in the game system 1.

Here, according to the above non-limiting variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the above steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several non-limiting example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

As described above, the present example can, for example, be used as an information processing program, information processing system, information processing apparatus, and information processing method that are capable of improving the user's motivation for removing a stage object.

What is claimed is:

1. A non-transitory computer-readable storage medium having stored therein an information processing program that, when executed, causes one or more processors of an information processing apparatus to execute information processing comprising:
removing at least a portion of a stage object included in a game stage in a virtual space, based on a user's operation input;
calculating a cumulative value of reduced amounts of the stage object caused by the removal in the virtual space; and
placing a placed object different from the stage object in the vicinity of a location where the stage object has been removed, depending on the cumulative value.

2. The non-transitory computer-readable storage medium according to claim 1, wherein
the placing the placed object includes placing the placed object with the placed object buried in a surface of the stage object in the vicinity of the location of the removal.

3. The non-transitory computer-readable storage medium according to claim 2, wherein
the removing the stage object includes releasing the placed object from a state of being buried in the stage object or causing the user to obtain the placed object, by further removing a portion of the stage object in which the placed object is buried, based on the operation input.

4. The non-transitory computer-readable storage medium according to claim 1, wherein
the placing the placed object includes placing the placed object when the cumulative value exceeds a reference value.

5. The non-transitory computer-readable storage medium according to claim 1, wherein
the calculating the cumulative value includes reducing the cumulative value when the placed object is placed as the cumulative value exceeds a reference value.

6. The non-transitory computer-readable storage medium according to claim 5, wherein
the calculating the cumulative value includes calculating the cumulative value for each type of a placed object that is to be placed, wherein when any of the placed objects is placed as the cumulative value exceeds the reference value, the cumulative value for the placed object is reduced.

7. The non-transitory computer-readable storage medium according to claim 6, wherein
the calculating the cumulative value includes setting different reference values for different types of placed objects that are to be placed.

8. The non-transitory computer-readable storage medium according to claim 1, wherein
the placing the placed object includes further forming a cavity in the stage object in the vicinity of the removed portion of the stage object, and placing the placed object in the cavity, depending on the cumulative value.

9. The non-transitory computer-readable storage medium according to claim 8, wherein
the placing the placed object includes not forming the cavity and not placing the placed object to be placed in the cavity, when there is not enough space in the stage object to form the cavity, depending on the cumulative value.

10. The non-transitory computer-readable storage medium according to claim 9, wherein
the calculating the cumulative value includes decreasing the cumulative value when the cavity is formed and the placed object is placed in the cavity, and maintaining the cumulative value unchanged when there is not enough space in the stage object to form the cavity.

11. The non-transitory computer-readable storage medium according to claim 9, wherein
the calculating the cumulative value includes decreasing the cumulative value to a first value when the cavity is formed and the placed object is placed in the cavity, and decreasing the cumulative value to the first value or a value greater than the first value when there is not enough space in the stage object to form the cavity.

12. The non-transitory computer-readable storage medium according to claim 8, wherein
the placing the placed object includes determining whether to further form the cavity and place the placed object in the cavity or place the placed object without further forming the cavity, depending on a direction in which the stage object has been removed.

13. The non-transitory computer-readable storage medium according to claim 1, wherein
the stage object has attribute information, and
the calculating the cumulative value includes varying an incremental amount of the cumulative value according to the attribute information even when the reduced amount is the same.

14. The non-transitory computer-readable storage medium according to claim 13, wherein
the removing the stage object includes varying a required amount of the operation input required for removing at least a portion of the stage object according to the attribute information, and
the calculating the cumulative value includes increasing an incremental amount of the cumulative value with an increase in the required amount even when the reduced amount is the same.

15. The non-transitory computer-readable storage medium according to claim 1, wherein
the stage object has attribute information, and
the placing the placed object includes determining whether or not to place the placed object, depending on the attribute information of the stage object in the vicinity of the location where the stage object has been removed.

16. The non-transitory computer-readable storage medium according to claim 2, wherein
the placing the placed object includes placing the placed object in a direction in which at least a portion of the stage object has been removed.

17. The non-transitory computer-readable storage medium according to claim 16, wherein
the placing the placed object includes placing, when the stage object is absent on an opposite side from a direction of gravity in the virtual space of a location where at least a portion of the stage object has been removed, the placed object at a location closer to the direction of gravity than the direction in which at least a portion of the stage object has been removed.

18. The non-transitory computer-readable storage medium according to claim 1, wherein
the stage object includes a mesh generated from voxel data including at least density data, and
the removing the stage object includes removing at least a portion of the stage object by changing the density data.

19. The non-transitory computer-readable storage medium according to claim 18, wherein
a reduced amount of the stage object formed of the mesh is allowed to take a value smaller than the amount of a voxel with which each of the voxel data is associated.

20. The non-transitory computer-readable storage medium according to claim 18, wherein
the removing the stage object includes placing, when at least a portion of the stage object is removed, an amount of voxel objects corresponding to the reduced amount on the stage object with the voxel objects separated from the stage object, and
the calculating the cumulative value includes calculating the reduced amount of the stage object, including the amount of voxel objects placed separately from the stage object.

21. The non-transitory computer-readable storage medium according to claim 1, wherein
the information processing further comprises:
controlling the player character's action in the virtual space, based on the operation input,
wherein
the removing the stage object includes removing at least a portion of the stage object according to the player character's action in the virtual space, and
the calculating the cumulative value includes calculating a cumulative value of reduced amounts of the stage object removed according to the player character's action.

22. The non-transitory computer-readable storage medium according to claim 21, wherein
the information processing further comprises:
controlling an action in the virtual space of an opponent character different from the player character,
wherein
the removing the stage object includes removing at least a portion of the stage object according to the opponent character's action in the virtual space, and
in the calculating the cumulative value, a reduced amount of the stage object removed according to the opponent character's action is not used in the calculation of the cumulative value.

23. A non-transitory computer-readable storage medium having stored therein an information processing program that, when executed, causes one or more processors of an information processing apparatus to execute information processing comprising:
removing at least a portion of a stage object included in a game stage in a virtual space, based on a user's operation input; and
placing and burying a placed object different from the stage object in a surface of the stage object in the vicinity of a location where the stage object has been removed, depending on the removal,
wherein
the removing the stage object includes releasing the placed object from a state of being buried in the stage object or causing the user to obtain the placed object, by further removing a portion of the stage object in which the placed object is buried, based on the operation input.

24. An information processing system comprising:
one or more processors that are configured to execute information processing comprising;
removing at least a portion of a stage object included in a game stage in a virtual space, based on a user's operation input;
calculating a cumulative value of reduced amounts of the stage object caused by the removal in the virtual space; and
placing a placed object different from the stage object in the vicinity of a location where the stage object has been removed, depending on the cumulative value.

25. An information processing system comprising:
one or more processors that are configured to execute information processing comprising;
removing at least a portion of a stage object included in a game stage in a virtual space, based on a user's operation input; and
placing and burying a placed object different from the stage object in a surface of the stage object in the vicinity of a location where the stage object has been removed, depending on the removal,
wherein
the removing the stage object includes releasing the placed object from a state of being buried in the stage object or causing the user to obtain the placed object, by further removing a portion of the stage object in which the placed object is buried, based on the operation input.

26. An information processing method comprising:
removing at least a portion of a stage object included in a game stage in a virtual space, based on a user's operation input;
calculating a cumulative value of reduced amounts of the stage object caused by the removal in the virtual space; and
placing a placed object different from the stage object in the vicinity of a location where the stage object has been removed, depending on the cumulative value.

27. An information processing method comprising:
removing at least a portion of a stage object included in a game stage in a virtual space, based on a user's operation input; and
placing and burying a placed object different from the stage object in a surface of the stage object in the vicinity of a location where the stage object has been removed, depending on the removal,
wherein
the removing the stage object includes releasing the placed object from a state of being buried in the stage object or causing the user to obtain the placed object, by further removing a portion of the stage object in which the placed object is buried, based on the operation input.
